(19) United States
(12) Patent Application Publication
(10) Pub. No.: US 2011/0037720 A1
(43) Pub. Date: Feb. 17, 2011

(54) MOBILE INFORMATION TERMINAL, COMPUTER-READABLE PROGRAM, AND RECORDING MEDIUM

(76) Inventors: Keiko Hirukawa, Osaka (JP); Toshio Akabane, Osaka (JP); Tomokazu Morio, Osaka (JP); Keiichiro Sato, Osaka (JP)

Correspondence Address: BIRCH STEWART KOLASCH & BIRCH, PO BOX 747, FALLS CHURCH, VA, 22040-0747, US

(21) Appl. No.: 12/989,318

(22) PCT Filed: Apr. 20, 2009
(86) PCT No.: PCT/JP2009/057838

§ 371 Date: Oct. 22, 2010

(30) Foreign Application Priority Data
Apr. 23, 2008 (JP) 2008-112849
Mar. 17, 2009 (JP) 2009-064587

(51) Int. Cl. G06F 3/041

(52) U.S. Cl. 345/173

(57) ABSTRACT

A mobile phone is disclosed wherein an operation window is displayed on a display unit. Buttons for input of information for controlling processing related to an application executed in the mobile phone are displayed in the operation window. A touch panel is provided on the display unit. When a user drags his/her finger on the touch panel as indicated by an arrow, a display position of the operation window is shifted so as to be dragged by the user's finger.

### TECHNICAL FIELD

The present invention relates to a mobile information terminal, and more particularly to a mobile information terminal allowing for operation of a touch panel displayed on a display unit, a computer-readable program, and a recording medium.

### BACKGROUND ART

In conventionally utilized various types of techniques for information terminals having a display unit provided with a touch panel, video is displayed on the display unit, and an image corresponding to an operation unit is also displayed for a user to operate the touch panel, so that an input of operation information is accepted.

In some of these techniques, for example, a user touch triggers an operation window as described above to be displayed.

Patent Document 1 (Japanese Patent Laying-Open No. 2007-52795) discloses a technique for a digital camera of, when a user touch on a touch panel is detected, displaying an image including operation buttons, such as a shutter button, a zoom-in button, and a zoom-out button, relative to a touch position on the touch panel for user convenience of operation.

### Patent Document 1: Japanese Patent Laying-Open No. 2007-52795

### DISCLOSURE OF THE INVENTION

### Problems to be Solved by the Invention

To hold and operate a mobile information terminal by one hand, there has been a growing user demand to operate the terminal by a finger of one hand while holding the terminal by that hand. Many mobile information terminals are accordingly manufactured on the assumption that they are held and operated by one hand.

Meanwhile, in recent years, mobile information terminals have been equipped with an increasing number of functions. Demand is growing accordingly that more information, such as buttons and menus, is displayed in the operation window displayed on the display unit.

As information displayed in the operation window increases, the area required of the operation window is expected to increase. As the operation window increases in area, a situation is assumed to arise, where even when the operation window is displayed at a position supposed to be easily operated by a user as disclosed in the above-mentioned Patent Document 1, the user may not actually feel the operability. More specifically, even when the operation window is displayed at a position supposed to be easily operated by the user, a button located at the corner of the operation window may be too far for the user to operate by a finger of one hand holding the terminal. For operating the button in such a case, the user needs to change the position of his/her hand holding the terminal or to operate the button by the other hand.

The present invention was made in light of these circumstances, and an object of the invention is to ensure improved user convenience of a mobile information terminal displaying an operation window on a touch panel provided on a display unit.

### Means for Solving the Problems

A mobile information terminal in accordance with an aspect of the present invention includes a display unit, a touch panel arranged in the display unit, an application execution unit executing an application, and a controller executing processing related to the application in accordance with an operation on the touch panel. The controller displays, on the display unit, an operation window in which information for use in the processing related to the application is input, and shifts a display position of the operation window on the display unit based on a first operation on the touch panel.

A mobile information terminal in accordance with another aspect of the present invention includes a display unit, a touch panel arranged in the display unit, an application execution unit executing an application, and a controller executing processing related to the application in accordance with an operation on the touch panel. The controller displays, on the display unit, an operation window in which information for use in the processing related to the application is input. The controller shifts a display position of the operation window on the display unit based on a first operation on the touch panel. The controller is capable of returning the display position of the operation window shifted by the first operation, to a position before being shifted. When an operation is performed on the touch panel, the controller determines whether or not the operation satisfies a requirement for the first operation, and when determining that the requirement is satisfied, shifts the display position of the operation window on the display unit.

A mobile information terminal in accordance with a yet another aspect of the present invention includes a display box, a touch panel arranged in the display box, an application execution unit executing an application, and a controller executing processing related to the application in accordance with an operation on the touch panel. An operation window of the application is larger than a size of the display box. The controller displays, on the display box, a partial window constituting a portion of the operation window. The partial window includes items for input of information for use in the processing related to the application. In response to a first operation on the touch panel, the controller changes the portion of the operation window displayed on the display box as the partial window, and determining that information for selecting from among the items has been input by a second operation performed on the partial window as changed, executes the processing related to the application corresponding to a selected item. When the first operation is performed with the partial window located at an end of the operation window, the controller displays the end of the operation window at a shifted position in the display box from an end of the display box in a direction identical to an operation direction in the first operation. When the second operation is performed on the operation window located at the shifted position, the controller, determining that the information for selecting from among the items has been input, executes the processing related to the application corresponding to the selected item.

A computer-readable program in accordance with the present invention is a computer-readable program for controlling a mobile information terminal including a display unit, a touch panel arranged in the display unit, and an application execution unit executing an application. The computer-readable program causes the mobile information terminal to execute the steps of displaying, on the display unit, an operation window in which information for use in processing related to the application is input, determining whether or not an operation on the touch panel is performed, and shifting a display position of the operation window on the display unit based on the operation on the touch panel.

A recording medium in accordance with the present invention is a recording medium storing a computer-readable program for controlling a mobile information terminal including a display unit, a touch panel arranged in the display unit, and an application execution unit executing an application. The computer-readable program causes the mobile information terminal to execute the steps of displaying, on the display unit, an operation window in which information for use in processing related to the application is input, determining whether or not an operation on the touch panel is performed, and shifting a display position of the operation window on the display unit based on the operation on the touch panel.

### EFFECTS OF THE INVENTION

According to the present invention, the display position of the operation window displayed on the display unit can be shifted based on an operation on the touch panel.

Therefore, even when a button that a user intends to operate in the operation window displayed on the display unit is located too far from a finger of a user's hand holding the mobile information terminal, the user can shift the display position of the button closer to that finger. The user can then operate the operation window at a desired position, such as a desired button, without having to change the position of his/her hand holding the mobile information terminal, for example.

### BRIEF DESCRIPTION OF THE DRAWINGS

FIG. 1A schematically shows a surface of a mobile phone according to an embodiment of a mobile information terminal of the present invention.

FIG. 1B schematically shows a surface of a mobile phone according to an embodiment of a mobile information terminal of the present invention.

FIG. 1C schematically shows a surface of a mobile phone according to an embodiment of a mobile information terminal of the present invention.

FIG. 1D schematically shows a surface of a mobile phone according to an embodiment of a mobile information terminal of the present invention.

FIG. 1E schematically shows a surface of a mobile phone according to an embodiment of a mobile information terminal of the present invention.

FIG. 2 schematically shows a hardware configuration of the mobile phone shown in FIG. 1A.

FIG. 3A shows an example of an operation window displayed on the display unit of the mobile phone shown in FIG. 1A.

FIG. 3B shows an example of an operation window displayed on the display unit of the mobile phone shown in FIG. 1A.

FIG. 4A schematically shows an example of changing a display mode of the operation window on the display unit of the mobile phone shown in FIG. 1A.

FIG. 4B schematically shows the example of changing the display mode of the operation window on the display unit of the mobile phone shown in FIG. 1A.

FIG. 5A schematically shows another example of changing the display mode of the operation window on the display unit of the mobile phone shown in FIG. 1A.

FIG. 5B schematically shows another example of changing the display mode of the operation window on the display unit of the mobile phone shown in FIG. 1A.

FIG. 6A explains a procedure for changing the display mode of the operation window of the mobile phone shown in FIG. 1A.

FIG. 6B explains a procedure for changing the display mode of the operation window of the mobile phone shown in FIG. 1A.

FIG. 7 explains a procedure for changing the display mode of the operation window of the mobile phone shown in FIG. 1A.

FIG. 8 explains a procedure for changing the display mode of the operation window of the mobile phone shown in FIG. 1A.

FIG. 9 explains a procedure for displaying the operation window of the mobile phone shown in FIG. 1A.

FIG. 10 explains a procedure for displaying the operation window of the mobile phone shown in FIG. 1A.

FIG. 11A explains a procedure for displaying the operation window of the mobile phone shown in FIG. 1A.

FIG. 11B explains a procedure for displaying the operation window of the mobile phone shown in FIG. 1A.

FIG. 12 explains a procedure for displaying the operation window of the mobile phone shown in FIG. 1A.

FIG. 13 explains a procedure for displaying the operation window of the mobile phone shown in FIG. 1A.

FIG. 14 explains a procedure for displaying the operation window of the mobile phone shown in FIG. 1A.

FIG. 15 is a flow chart of an interrupt process executed by a CPU of the mobile phone shown in FIG. 1A.

FIG. 16 is a flow chart of a single tap/double tap distinction process executed by the CPU of the mobile phone shown in FIG. 1A.

FIG. 17 is a flow chart of a first-display-mode change process executed by the CPU of the mobile phone shown in FIG. 1A.

FIG. 18 is a flow chart of a menu drag process executed by the CPU of the mobile phone shown in FIG. 1A.

FIG. 19 is a flow chart of the menu drag process executed by the CPU of the mobile phone shown in FIG. 1A.

FIG. 20 shows a variation of the flow chart shown in FIG. 18.

FIG. 21 shows a variation of the flow chart shown in FIG. 18.

FIG. 22 shows a variation of the flow chart shown in FIG. 18.

FIG. 23 shows a variation of the flow chart shown in FIG. 18.

FIG. 24 is a flow chart of a menu-position return process executed by the CPU of the mobile phone shown in FIG. 1A.

FIG. 25 is a flow chart of a second-display-mode change process executed by the CPU of the mobile phone shown in FIG. 1A.

FIG. 26 schematically shows yet another example of changing the display mode of the operation window on the display unit of the mobile phone shown in FIG. 1A.

FIG. 27A schematically shows still another example of changing the display mode of the operation window on the display unit of the mobile phone shown in FIG. 1A.

FIG. 27B schematically shows still another example of changing the display mode of the operation window on the display unit of the mobile phone shown in FIG. 1A.

FIG. 27C schematically shows still another example of changing the display mode of the operation window on the display unit of the mobile phone shown in FIG. 1A.

FIG. 28A explains the change in the display mode of the operation window shown in FIGS. 27A to 27C.

FIG. 28B explains the change in the display mode of the operation window shown in FIGS. 27A to 27C.

FIG. 28C explains the change in the display mode of the operation window shown in FIGS. 27A to 27C.

### BEST MODES FOR CARRYING OUT THE INVENTION

A mobile phone according to an embodiment of a mobile information terminal of the present invention will be described hereinbelow with reference to the drawings. It is to be noted that the mobile information terminal according to the present invention is not limited to the mobile phone. More specifically, the mobile information terminal according to the present invention may be any terminal provided with a touch panel, and is not required to have a specific function, such as a verbal communications function provided for a mobile phone, for example.

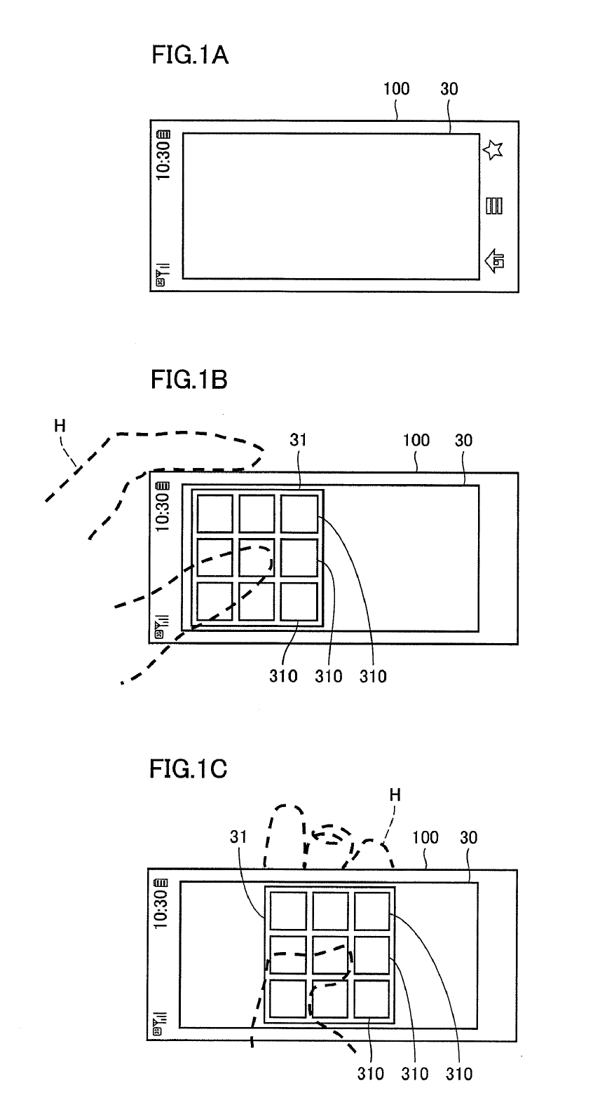

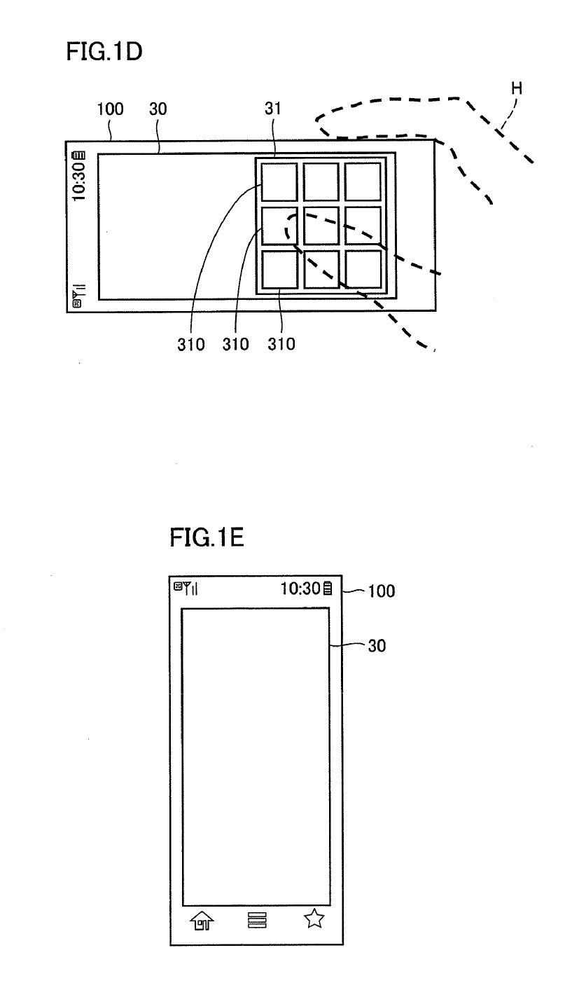

FIGS. 1A to 1E schematically show a surface of a mobile phone according to an embodiment of a mobile information terminal of the present invention.

First, with reference to FIG. 1A, a display unit 30 made of a liquid crystal display or the like is provided on a surface of a mobile phone 100. Display unit 30 is capable of displaying various types of information including a document on a network such as a Web page, an address book stored in mobile phone 100, and a window for creating an e-mail using a mailer.

Mobile phone 100 is provided with a touch panel (a touch panel 40 which will be described later) on the front face of display unit 30. In mobile phone 100, an operation window 31 for input of information for use in a process related to an application executed in mobile phone 100 is displayed. An area of the touch panel that corresponds to a left area of display unit 30 is touched or otherwise operated, so that operation window 31 is displayed in the left area of display unit 30 as shown in FIG. 1B, for example. Alternatively, an area of the touch panel that corresponds to a central area of display unit 30 is touched or otherwise operated, so that operation window 31 is displayed in the central area of display unit 30 as shown in FIG. 1C. Alternatively, an area of the touch panel that corresponds to a right area of display unit 30 is touched or otherwise operated, so that operation window 31 is displayed in the left area of display unit 30 as shown in FIG. 1D.

In FIGS. 1B to 1D, broken lines H schematically indicate fingers of a user operating the touch panel of mobile phone 100.

Operation window 31 includes a plurality of operation buttons 310 that correspond to individual functions, respectively. Mobile phone 100 stores as appropriate which button of plurality of operation buttons 310 on operation window 31 corresponding to which function is displayed at which position on the touch panel. Mobile phone 100 then detects such information and detects at which position the touch panel is operated, to thereby determine a procedure to be executed.

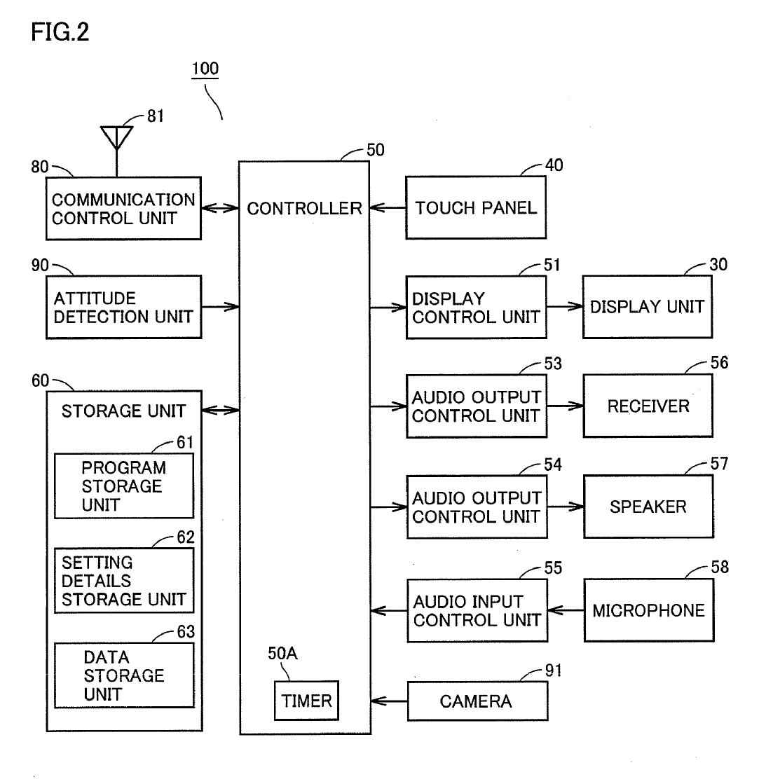

FIG. 2 schematically shows a hardware configuration of mobile phone 100.

With reference to FIG. 2, mobile phone 100 includes a controller 50 controlling the operation of mobile phone 100 as a whole, an antenna 81 for data transmission/reception, a communication control unit 80 performing signal processing and so forth in data transmission/reception by antenna 81, an attitude detection unit 90 detecting an attitude of the mobile phone, a storage unit 60 implemented by a flash memory or the like, touch panel 40, display unit 30, a display control unit 51 controlling display details on display unit 30, a receiver 56 and a microphone 58 mainly used for the verbal communications function, a speaker 57 outputting an alarm sound and the like, an audio output control units 53 and 54 controlling audio to be output from the receiver and speaker 57, an audio input control unit 55 processing audio having been input to microphone 58, and a cameral 91. Controller 50 includes a CPU. Controller 50 also includes a timer 50A.

Attitude detection unit 90 is to detect the orientation and the moving direction of mobile phone 100 as well as an acceleration given to mobile phone 100, and includes a plurality of gyroscopes, acceleration sensors, and geomagnetic sensors, for example. The orientation of mobile phone 100 includes, for example, a horizontally-long state when held by the user as shown in FIG. 1A (and FIGS. 1B to 1D), a vertically-long state when held by the user as shown in FIG. 1E, and so on. Well-known techniques can be applied to detect the orientation, the moving direction, and the acceleration of mobile phone 100 itself with attitude detection unit 90, which will not be described herein.

Storage unit 60 includes a program storage unit 61 storing programs executed by the CPU of controller 50, a setting details storage unit 62 storing details of setting, such as an address book, made in mobile phone 100, and a data storage unit 63 storing various tables which will be described later and various types of data required to execute the programs stored in program storage unit 61. Program storage unit 61 may be fixed to or may be removable from mobile phone 100.

Details of a procedure executed in mobile phone 100 will now be described.

FIG. 15 is a flow chart of an interrupt process executed by the CPU, in relation to the display on operation window 31. The CPU executes the process at certain time intervals (e.g., 200 ms).

With reference to FIG. 15, at step S1, the CPU first checks an activation state of an application in mobile phone 100, and then advances the process into step S2.

In mobile phone 100, an operation that can be accepted subsequently and a type of application that can be activated in combination often vary depending on an application being activated. This raises the need to change the contents displayed as a menu, or as the case may be, to avoid the process of displaying a menu by checking the state of mobile phone 100, such as whether no application is activated, which application among the television function, the Web browser function, the e-mail function, and the like is activated, or whether a telephone conversation is being made. From these reasons, the activation state of an application is checked at step S1 (e.g., as to which application is activated).

At step S2, the CPU checks the state of touch panel 40, and then advances the process into step S3.

Generally, in an operating system (OS) of an information terminal, the input function through the touch panel is not offered by each application, but is provided in many cases as a function of the OS. Except for a brief time period after a touch on the touch panel is finished, during which a menu or screen transition may be displayed in an animated manner, the process of displaying a menu is often unexecuted until a touch operation is performed, so that power consumption is reduced. The following description will be made assuming that, except for some cases, checking the touch state on the touch panel is executed outside a menu control process, and that the touch state shall not be changed during execution of an algorithm for the menu control process.

At step S3, the CPU determines whether or not calling of the menu control process at step S5 which will be described later is necessary. When a determination is made that calling is necessary, the process proceeds into step S5. When a determination is made that calling is unnecessary, the process proceeds into step S4.

At step S4, the CPU waits the lapse of the above-mentioned certain interval after the execution of the current main routine is started, and then returns the process to step S1.

At step S5, the CPU, after executing the menu control process, waits the lapse of the above-mentioned certain interval after the execution of the current main routine, and then returns the process to step S1.

In the menu control process at step S5, various types of processing including the following five types of processing are executed in parallel or sequentially:
Touch-operation-type identification process;
First-display-mode change process;
Menu drag process;
Menu-position return process; and
Second-display-mode change process.

The touch-operation-type identification process is to identify the type of operation pattern performed on touch panel 40, based on a user operation on touch panel 40.

The first-display-mode change process is executed when the display of operation window 31 on display unit 30 is started. Throughout the present specification, operation window 31 will also be called “menu” as necessary.

The menu drag process is to shift the display position of operation window 31 displayed on display unit 30 by, for example, sliding operation window 31 in accordance with the user operation performed on touch panel 40.

The menu-position return process is to return the display position of the operation window having been shifted in display position by the above-described menu drag process to the position before the shift.

The second-display-mode change process is executed when the display of operation window 31 on display unit 30 is terminated.

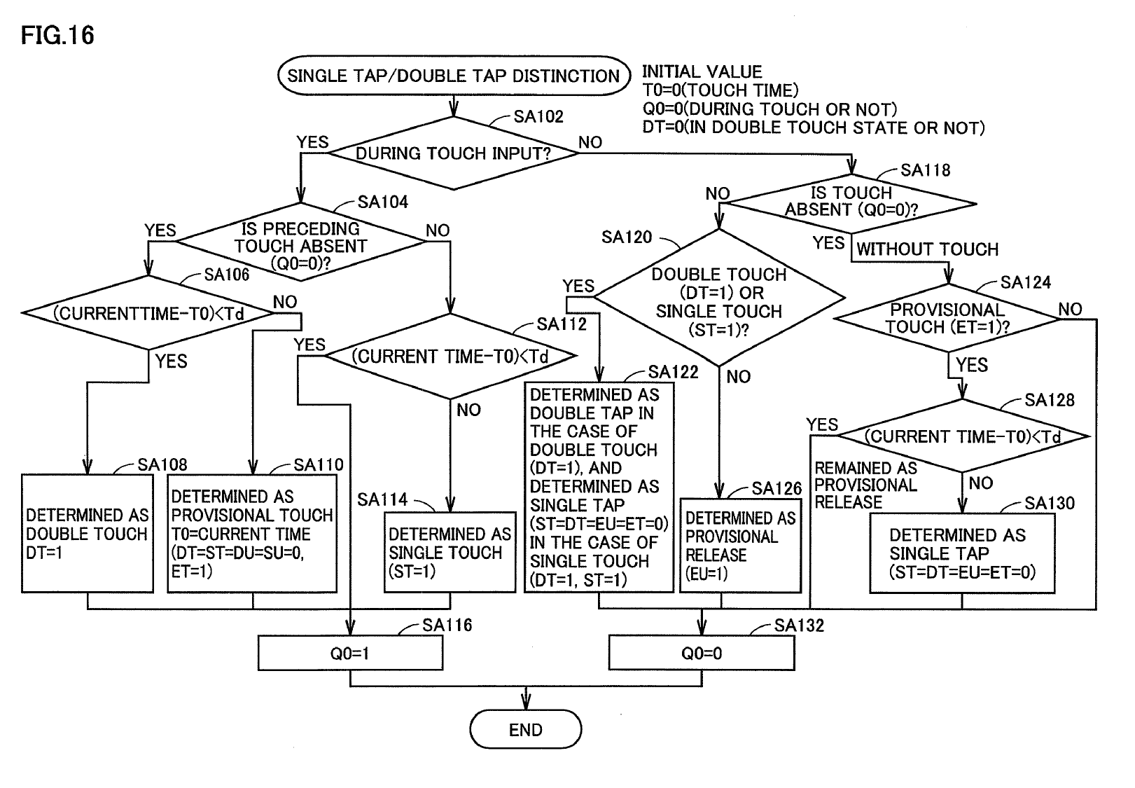

In mobile phone 100, the type of touch operation includes a single tap, a double tap, a drag, and so on. In the present specification, distinction between a single tap and a double tap will be described with reference to the flow chart of a single tap/double tap distinction process shown in FIG. 16. The internal conditions during the single tap/double tap distinction process are summarized in Table 1.

It is to be noted that the following mode of identifying the type of touch operation is merely for illustration. In the mobile information terminal, the type of touch operation may be identified by another mode generally used, rather than the method described in the present specification.

TABLE 1
Touch Operation Details Table

| Touch operation | Details |
|---|---|
| Single touch | A touch on the touch panel continuing for a time |
| | period shorter than a certain time period |
| Single tap | A touch on the touch panel continuing for a time |
| | period shorter than a certain time period, followed |
| | by a touch-and-release |
| Double touch | Two touches performed during a predetermined time |
| | period within a range less than a certain distance in |
| | the touch panel |
| Provisional touch | A touch detected for the first time and before a |
| | provisional release |
| Provisional release | A touch-and-release detected after a provisional |
| | touch is detected, and before turning out to be either |
| | a single tap or a double touch |

With reference to FIG. 16, in the touch-operation-type identification process, the CPU first determines at step SA102 whether or not the user touches touch panel 40. When a YES determination is made, the process proceeds into step SA104, and when a NO determination is made, the process proceeds into step SA118.

At step SA104, the CPU determines whether or not the value of a during-touch flag Q0, which indicates whether or not a touch operation has been performed during execution of a preceding touch-operation-type identification process, is 0. When a YES determination is made, the process proceeds into step SA106, and a NO determination is made, that is, when a determination is made that the value of during-touch flag Q0 is 1, the process proceeds into step SA112.

It is to be noted that, as will be described later, during-touch flag Q0 is a flag whose value is updated every time the touch-operation-type identification process is executed, with the value set at 1 when a touch operation is currently performed on touch panel 40, and the value set at 0 when a touch operation is not performed.

At step SA106, the CPU determines whether or not the difference between the current time and a touch start time T0 falls below a predetermined threshold value Td. When a YES determination is made, the process proceeds into step SA108, and when a NO determination is made, that is, when a determination is made that the touch operation on touch panel 40 continues for a time period longer than or equal to above-mentioned time Td, the process proceeds into step SA110.

At step SA108, the CPU determines that the current operation on touch panel 40 is a double touch, and advances the process into step SA116. It is to be noted that, at step SA108, a double-touch-state flag DT, which indicates whether or not mobile phone 100 is subjected to a double touch operation (double touch state), is set at 1.

At step SA110, the CPU determines that the current operation on touch panel 40 is a provisional touch, sets the value of a provisional-touch-state flag ET at 1, records the current time timed by timer 50A as the value of touch start time T0, sets the values of above-mentioned double-touch-state flag DT, a single-touch-state flag ST, a double-tap-state flag DU, and a single-tap-state flag SU, which will be described later, at 0, and then advances the process into step SA116.

It is to be noted that data storage unit 63 stores a touch information storage table as shown in Table 2, as a table for storing values used when various processes including the touch-operation-type identification process are executed.

TABLE 2
Touch Information Storage Table

| Item | Details |
|---|---|
| Touch start position P0 | Information indicating the position at |
| | which a touch operation on the touch |
| | panel is started |
| Touch start time T0 | Information indicating the time at which a |
| | touch operation on the touch panel is |
| | started |
| Touch position P1 | Information indicating the touch position |
| | on the touch panel at the time point when |
| | CPU executes processing |
| Touch time T1 | Information indicating the time recorded |
| | when a touch operation is detected while |
| | CPU executes various types of processing |

In the touch information storage table, touch start position P0 is information indicating the position at which the user has started a touch operation on touch panel 40, and is represented, for example, by coordinates defined on touch panel 40 or the like. More specifically, the coordinates indicate the position at which the user has started touching touch panel 40.

It is to be noted that values of the respective items in the touch information storage table are updated when a provisional touch is detected.

Touch start time T0 indicates the time at which the user has started the touch operation on touch panel 40, as described above.

Touch position P1 is information indicating the current touch position at which the user touches touch panel 40 while the CPU executes various types of processing including the touch-operation-type identification process.

Touch time T1 is information indicating the time recorded when a user's touch is detected while the CPU executes various types of processing.

Referring back to FIG. 16, at step SA112, the CPU determines whether or not the difference between the current time and touch start time T0 is shorter than time Td, similarly to step SA106. When a YES determination is made, the process proceeds into step SA116. When the difference between the current time and touch start time T0 is longer than or equal to time Td, the CPU advances the process into step SA114.

At step SA114, the CPU sets single-touch-state flag ST at 1 determining that the type of touch operation is a single touch, and then advances the process into step SA116.

At step SA116, the CPU sets the value of above-described during-touch flag Q0 at 1, and terminates the touch-operation-type identification process.

At step SA118, the CPU determines whether or not the value of during-touch flag Q0 is 0. When a determination is made that the value is 0, the process proceeds into step SA124. When a determination is made that the value of during-touch flag Q0 is 1, the process proceeds into step SA120.

At step SA120, the CPU determines whether the value of double-touch-state flag DT is 1 or the value of single-touch-state flag ST is 1. When a YES determination is made, the process proceeds into step SA122, and when a NO determination is made, that is, when a determination is made that double-touch-state flag DT and single-touch-state flag ST both have the value of 0, the process proceeds into step SA126.

At step SA122, the CPU determines that the type of operation is a double tap when the current value of double-touch-state flag DT is 1, and determines that the type of operation is a single tap when the value of double-touch-state flag DT is 0 and the value of single-touch-state flag ST is 1. In the case of a double tap, the value of double-tap-state flag DU is set at 1. In the case of a single tap, the value of single-tap-state flag SU is set at 1. The values of double-touch-state flag DT, single-touch-state flag ST, provisional-touch-state flag ET, and a provisional-release-state flag EU are all updated to 0.

At step SA124, a determination is made whether or not the value of provisional-touch-state flag ET is 1. When a YES determination is made, the process proceeds into step SA128, and when a NO determination is made, the process proceeds into step SA132.

At step SA126, the value of provisional-release-state flag EU is at 1 with a determination that the current operation is a provisional release, and the process proceeds into step S132.

At step SA128, the CPU determines whether or not the difference between the current time and touch start time T0 is shorter than time Td, similarly to step SA106. When a YES determination is made, the process proceeds into step SA132. When a determination is made that the difference is longer than or equal to Td, the process proceeds into step SA130.

At step SA130, the CPU sets the value of single-tap-state flag SU at 1 determining that the current touch operation is a single tap. The values of single-touch-state flag ST, double-touch-state flag DT, provisional-release-state flag EU, and provisional-touch-state flag ET are all updated to 0, and the process proceeds into step SA132.

At step SA132, the value of during-touch flag Q0 is updated to 0 to terminate the touch-operation-type identification process.

The values of flags for use in the respective processes including the above-described touch-operation-type identification process are stored in data storage unit 63 as a table as shown in Table 3, for example.

TABLE 3
Touch-type Identification Result Storage Table

| Flag | Value |
|---|---|
| Single-touch-state flag ST | (1 or 0) |
| During-touch flag Q0 | (1 or 0) |
| Double-touch-state flag DT | (1 or 0) |
| Provisional-touch-state flag ET | (1 or 0) |
| Provisional-release-state flag EU | (1 or 0) |
| Single-tap-state flag SU | (1 or 0) |
| Double-tap-state flag DU | (1 or 0) |

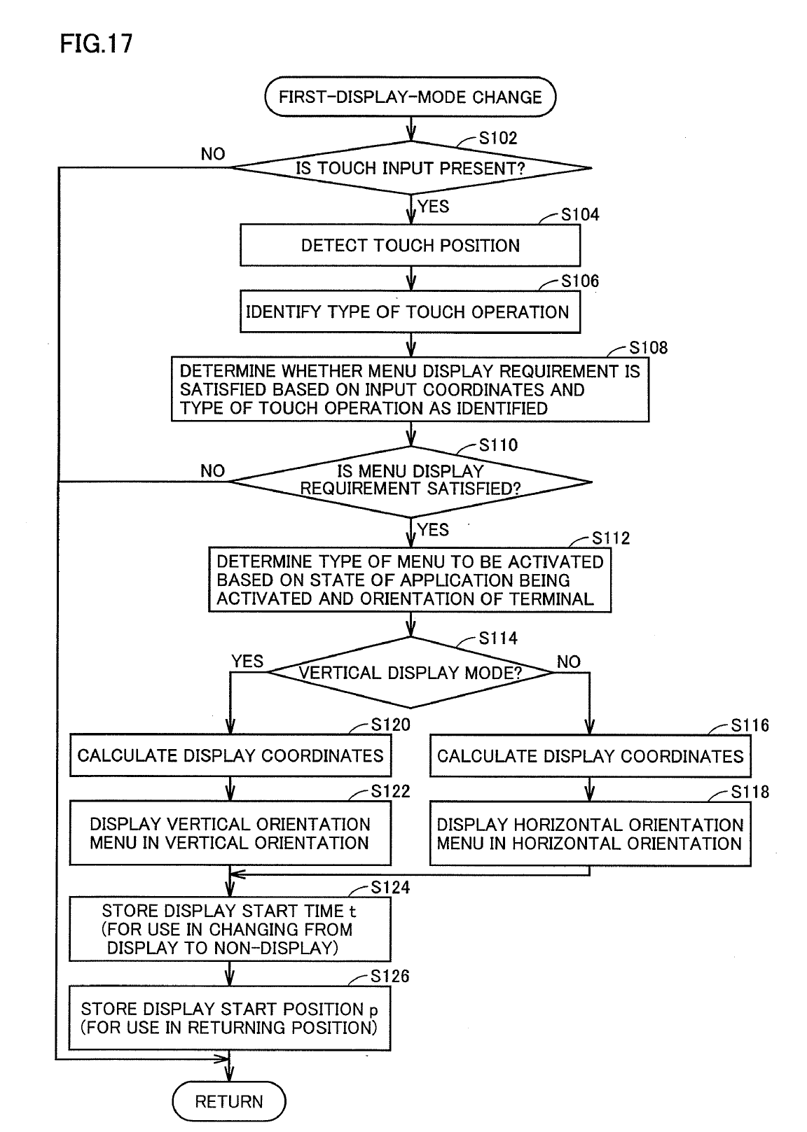

The first-display-mode change process will now be described with reference to FIG. 17 showing the flow chart of the process.

With reference to FIG. 17, in the first-display-mode change process, the CPU first determines at step S102 whether or not a touch operation is currently performed on touch panel 40, that is, whether a touch input is present or absent. When a determination is made that a touch input is present, the process proceeds into step S104, and when a NO determination is made, the first-display-mode change process is terminated.

At step S104, the CPU detects the current position at which touch panel 40 is operated (touch position), and advances the process proceeds into step S106.

At step S106, the CPU checks the type of touch operation by, for example, referring to the touch-type identification result storage table (Table 3), and advances the process proceeds into step S108.

At step S108, the CPU determines whether a menu display requirement is satisfied based on the touch position detected at step S104 and the type of touch operation checked at step S106.

At step S110, the CPU determines whether or not the menu display requirement is satisfied as a result of the determination at step S108. When a YES determination is made, the process proceeds into step S112, and when a NO determination is made, the first-display-mode change process is terminated. It is to be noted that the menu display requirement is determined previously depending on the type of touch operation, and are stored in setting details storage unit 62, for example.

At step S112, the type of menu (operation window) to be displayed on display unit 30 is determined based on the state of an application being activated in mobile phone 100 and the orientation of the mobile phone (e.g., the horizontally-long orientation as shown in FIG. 1A or the vertically-long orientation as shown in FIG. 1E), and the process proceeds into step S114.

In mobile phone 100, data storage unit 63 stores data for displaying various operation windows depending on the state of an application being activated.

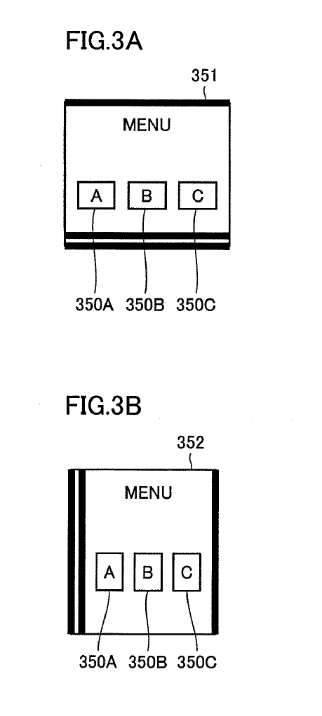

For each operation window, data storage unit 63 stores an operation window with a design including a button arrangement suitable for display on display unit 30 when mobile phone 100 is in the horizontal orientation, as well as data for displaying a window with a design suitable for display on display unit 30 when mobile phone 100 is in the vertical orientation. More specifically, data for displaying operation windows as shown in FIGS. 3A and 3B, for example, is included.

With reference to FIGS. 3A and 3B, a window 351 shown in FIG. 3A and a window 352 shown in FIG. 3B include buttons 350A, 350B, and 350C for input of identical information to mobile phone 100.

Window 351 has a horizontally-long design, and window 352 has a vertically-long design including buttons causing mobile phone 100 to exert identical functions of buttons 350A, 350B, and 350C included in window 351.

Window 351 is displayed on display unit 30 when mobile phone 100 is in the horizontal orientation as shown in FIG. 1A, and window 352 is displayed on display unit 30 when mobile phone 100 is in the vertical orientation as shown in FIG. 1E.

Referring back to FIG. 17, at step S114, the CPU determines whether or not mobile phone 100 is in the vertical orientation based on a detection output from attitude detection unit 90. When a YES determination is made, the process proceeds into step S120, and when a NO determination is made, that is, when a determination is made that mobile phone 100 is in the horizontal orientation, the process proceeds into step S116.

It is to be noted that the horizontal orientation shown in FIG. 1A is obtained by rotating the vertical orientation shown in FIG. 1E at an angle of 90 degrees, and vice versa. Mobile phone 100 is determined as being in the horizontal orientation when rotated clockwise and counterclockwise up to 45 degrees relative to the state shown in FIG. 1A, and in the vertical orientation when rotated clockwise and counterclockwise up to 45 degrees relative to the state shown in FIG. 1E.

At step S120, the CPU calculates coordinates at which operation window 31 is displayed on display unit 30, and advances the process into step S122. It is to be noted that coordinates at which display of operation window 31 is centered are calculated at step S120.

At step S122, the CPU displays a vertical orientation window at the coordinates calculated at step S120, and advances the process into step S124.

At step S116, the CPU calculates coordinates at which operation window 31 is displayed, and at step S118, displays a horizontal orientation window (e.g., window 351 shown in FIG. 3A) on display unit 30 at the coordinates calculated at step S116. The process then proceeds into step S124.

How to calculate the coordinates at steps S116 and S120 will now be described.

A first method may be to divide the touch panel into two areas A1 and A2 as indicated by long and short dashed lines in FIG. 9 to display operation window 31 in an area of display unit 30 that corresponds to area A1 when the touch position detected at step S104 falls within area A1, and to display operation window 31 in an area of display unit 30 that corresponds to area A2 when the touch position falls within area A2. The long and short dashed lines are defined as dividing display unit 30 and touch panel 40 provided on the front face of display unit 30 equally in the lateral direction.

A second method may be to display operation window 31 with a touch position B on touch panel 40 detected at step S104 being placed at the center in the lateral and longitudinal directions, as shown in FIG. 10.

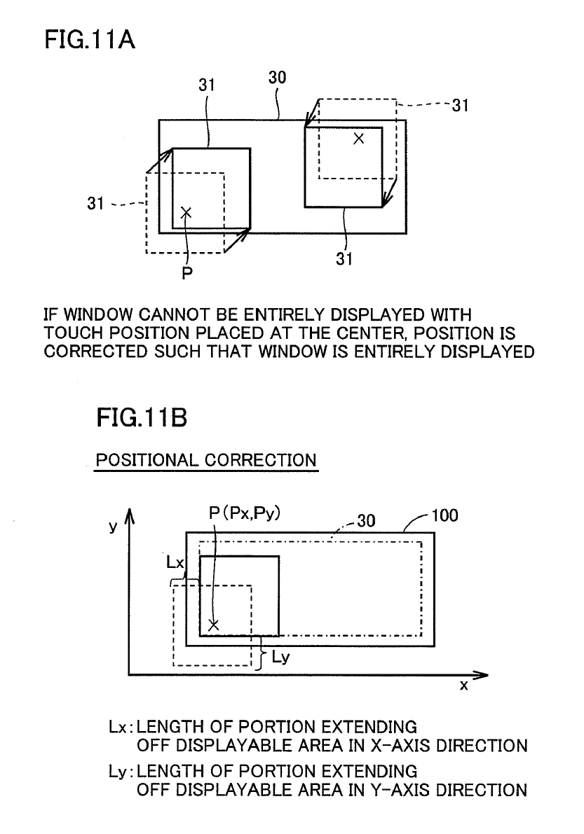

When operation window 31 is displayed with the touch position placed at the center, part of operation window 31 cannot be displayed on display unit 30 in some cases depending on the touch position, even when operation window 31 is to be displayed with the touch position placed at the center. In such a case, the display position of operation window 31 is preferably designed to fall within display unit 30 as shown in FIG. 11A. FIG. 11A shows operation window 31 yet to be corrected by broken lines, and operation window 31 having been corrected by solid lines. The shift of operation window 31 caused by a correction is indicated by arrows. The touch position is represented by 1P.

In a mode of correcting the display position of operation window 31, as shown in FIG. 11B, for example, defining the horizontal direction in FIG. 11B as an x direction, and the vertical direction as a y direction, a length extending off display unit 30 in the x-axis direction as Lx, and a length of a portion of operation window 31 extending off display unit 30 in the y-axis direction as Ly, then, the central coordinates of the display position of operation window 31 after the correction can be set at coordinates obtained by adding Lx to the x coordinate of the coordinates of a touch position and Ly to the y coordinate of the touch position.

Referring back to FIG. 17, at step S124, the CPU stores the current time as a display start time t, and advances the process into step S126.

At step S126, the CPU stores, as a display start position p, the central coordinates of operation window 31 (or the coordinates after the correction when a correction is made as described with reference to FIG. 11A, 11B or 12), to terminate the first-display-mode change process.

It is to be noted that above-mentioned display start time t and display start position p are stored in a display information storage table stored in data storage unit 63, for example. The details of the display information storage table are shown in Table 4, by way of example.

TABLE 4
Display Information Storage Table

| Item | Details |
|---|---|
| Display start time t | (Time information) |
| Display start position p | (Positional information) |

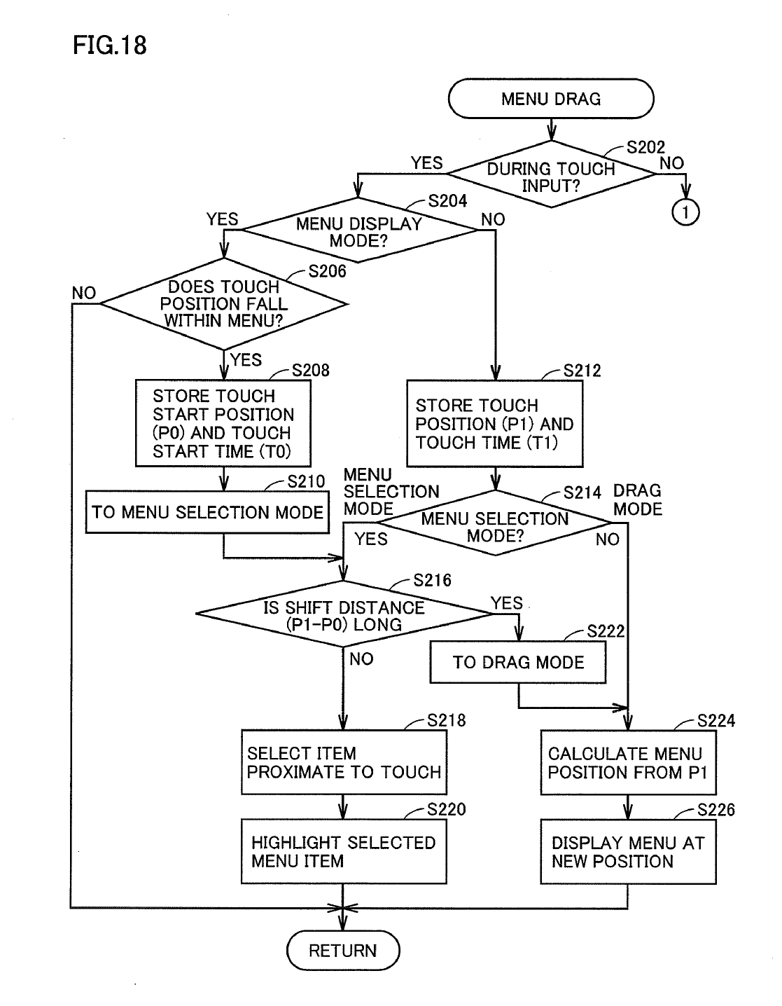

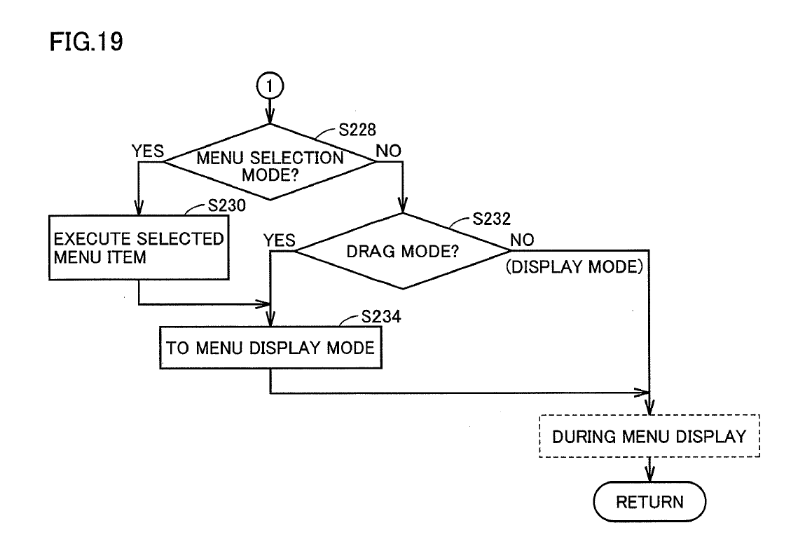

FIGS. 18 and 19 show flow charts of a menu drag process.

It is to be noted that a menu as used herein refers to an operation window for input of information for use in an application-related process, and includes a window object being displayed on the display unit subjected to a menu drag process.

In the menu drag process, the CPU first determines at step S202 whether or not a touch input is currently made on touch panel 40. When a YES determination is made, the process proceeds into step S204, and when a NO determination is made, the process proceeds into step S228.

At step S204, the CPU determines whether or not mobile phone 100 is in a menu display mode. When a YES determination is made, the process proceeds into step S206, and when a NO determination is made, the process proceeds into step S212.

Modes of mobile phone 100 will be described now.

Mobile phone 100 allows for selection from among four modes of the menu display mode, a menu selection mode, a drag mode, and a menu non-display mode, as shown in Table 5.

TABLE 5
Mode Information Storage Table

| Mode | ON/OFF |
|---|---|
| Menu display mode | Flag value (1 or 0) |
| Menu selection mode | Flag value (1 or 0) |
| Drag mode | Flag value (1 or 0) |
| Menu non-display mode | Flag value (1 or 0) |

The mode information storage table is stored in data storage unit 63, for example. The mode information storage table stores information by the flag value (1 or 0) so as to show either one of the four modes as shown in Table 5 is valid.

Referring back to FIG. 18, when a determination is made at step S204 that mobile phone 100 is in the menu display mode, the CPU determines at step S206 whether or not the touch position falls within an area corresponding to the menu (operation window 31). When a YES determination is made, the process proceeds into step S208, and when a NO determination is made, the menu drag process is terminated.

At step S208, the CPU stores the current touch position as touch start position P0 and the current time at this time point as touch start time T0, and advances the process into step S210. Touch start position P0 and touch start time T0 as used herein correspond to start position p and start time t shown in Table 4, respectively.

That the touch position falls within an area corresponding to operation window 31 means that the touch position falls within an area of touch panel 40 that is in pushing contact with the area in which operation window 31 is displayed on display unit 30.

At step S210, the CPU changes the mode of the mobile phone to the menu selection mode, and advances the process into step S216.

At step S212, the CPU stores the current touch position as touch position P1 and the current time as touch time T1, and advances the process into step S214.

At step S214, the CPU determines whether or not the current mode of mobile phone 100 is the menu selection mode or the drag mode. In the case of the menu selection mode, the process proceeds into step S216, and in the case of the drag mode, the process proceeds into step S224.

At step S216, the CPU calculates the difference between touch position P1 and touch start position P0 to obtain a shift distance, and determines whether or not the shift distance is longer than a predetermined certain threshold value. When a YES determination is made, the process proceeds into step S222, and when a NO determination is made, that is, when a determination is made that the shift distance is shorter than or equal to the threshold value, the process proceeds into step S218.

At step S222, the CPU changes the mode of mobile phone 100 to the drag mode, and advances the process into step S224.

At step S224, a new menu position is calculated based on touch position P1, and the process proceeds into step S226.

More specifically, the display position of new operation window 31 is calculated placing the central coordinates of the display position of new operation window 31 at touch position P1.

At step S226, the CPU changes the display position of operation window 31 on display unit 30 to the new position calculated at step S224, to terminate the menu drag process. Changing the display position is desirably performed such that the shift of the operation window from the initial position to the new position is displayed continuously on display unit 30, so that the display of operation window 31 appears to the user to be gradually shifting without disappearing from display unit 30.

In the above-described menu drag process, when mobile phone 100 is in the menu display mode and when the shift distance (P1−P0) of the user's finger on touch panel 40 is greater (longer) than the certain threshold value when touch panel 40 is operated continuously (successively), the display position of operation window 31 is shifted based the operation position (touch position P1) on touch panel 40 after the shift. Herein, the continuous operation of touch panel 40 includes a state in which a touch-and-release is never detected after the user starts touching on touch panel 40.

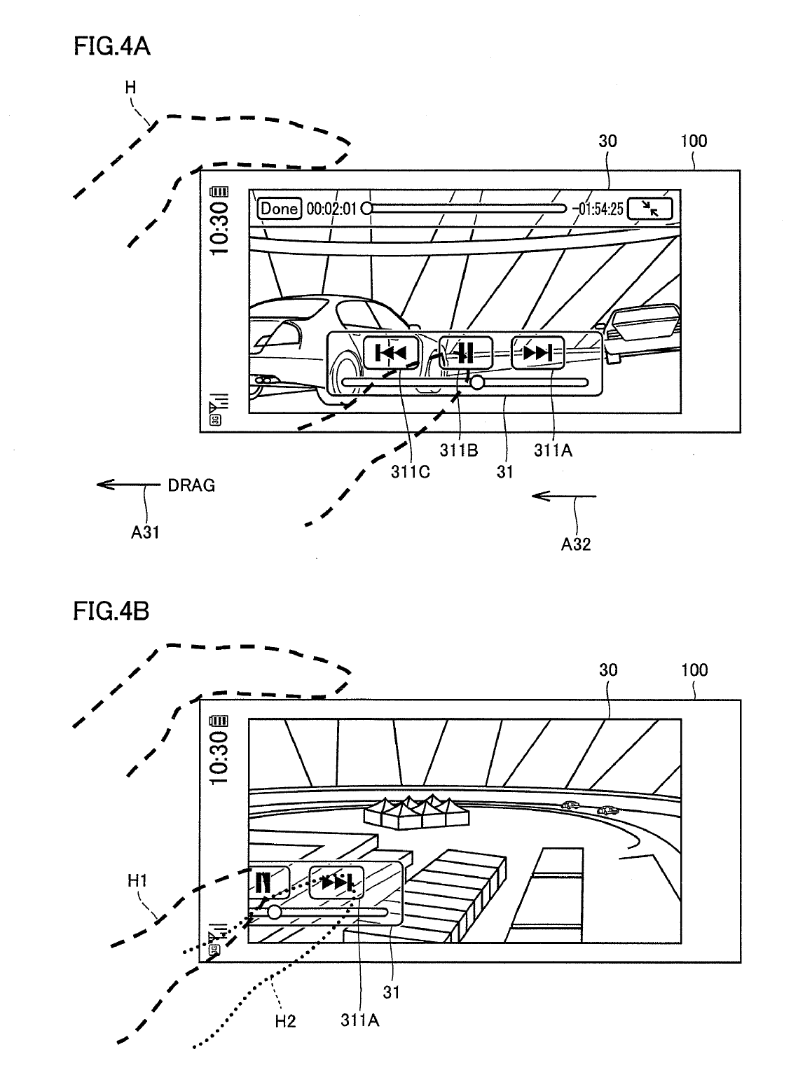

More specifically, as shown in FIG. 4A, when a user's finger indicated by broken lines is shifted (dragged) within operation window 31 to slide over touch panel 40 by a distance longer than the above-mentioned certain threshold value in the direction indicated by an arrow A31 with operation window 31 displayed on display unit 30, the display position of operation window 31 is shifted in the drag direction as shown in FIG. 4B. It is to be noted that operation window 31 includes images of buttons 311A to 311C.

In FIG. 4B, broken lines H1 indicate the user's finger having been dragged. In this state, the user can select from among the buttons in operation window 31 having been shifted by performing a touch-and-release, and then a touch operation, that is, by touching a position indicated by dotted lines H2 in FIG. 4B, for example. Dotted lines H2 indicate the user's finger selecting a button in operation window 31 having been shifted. Broken lines H1 indicate the finger performing a first touch operation. Dotted lines H2 indicate the finger performing a second touch operation. Operation window 31 having been shifted in display position by the first touch operation remains at that position after the first touch operation is finished, and mobile phone 100 accepts the second touch operation with operation window 31 remaining at the shifted display position.

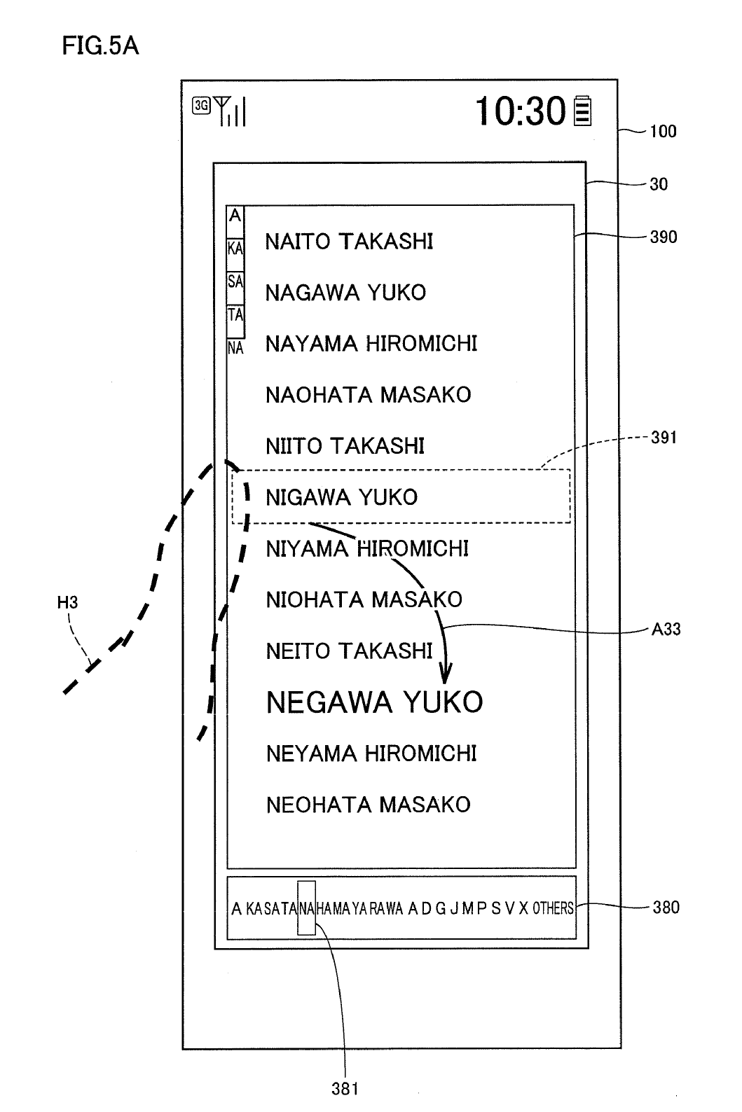

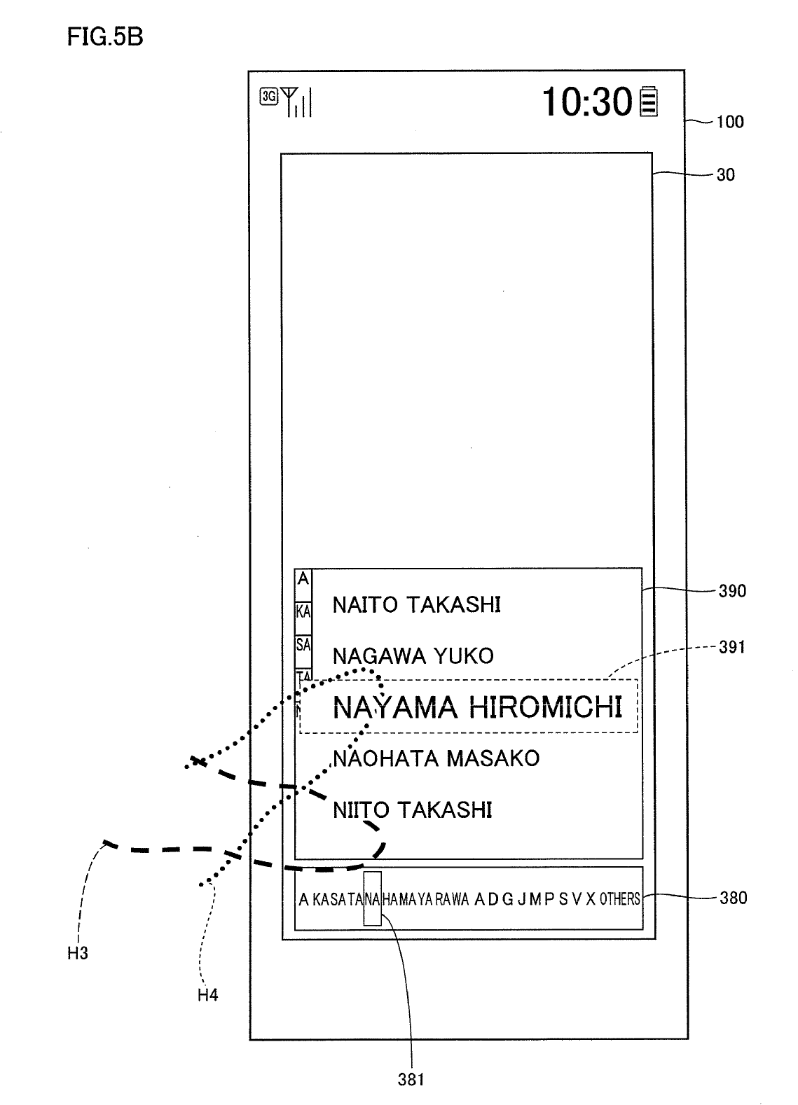

In another example, as shown in FIG. 5A, when the user's hand (finger) indicated by broken lines is dragged downwardly within an operation window 390 as indicated by an arrow A33 with operation window 390 displayed on display unit 30, the contents displayed on display unit 30 change as shown in FIG. 5B. In other words, the display position of operation window 390 on display unit 30 is shifted downwardly as shown in FIG. 5B.

Operation window 390 is a window with an address-book application activated. Displayed on display unit 30 is a cursor 381 indicating that “na” has been selected from among indices, such as “a”, “ka”, “ta”, “na”, displayed in a display box 380. Headers of individuals contained in the address book whose names start from the row of “na” are displayed in operation window 390. FIG. 5A shows a cursor 391 and the user's finger selecting the name of “Nigawa Yuko” displayed at the sixth position from the top of operation window 390. The drag operation is started from this state to shift the position of operation window 390 on display unit 30 downwardly, as shown in FIG. 5B. Broken lines H3 in FIG. 5B indicate the user's finger having been dragged. By performing a touch-and-release operation and then a touch operation on operation window 390 in the state shown in FIG. 5B, the user can select a name (in the address book displayed in operation window 30) to which the finger becomes accessible after the position shift. Dotted lines H4 indicate the user's finger selecting a name in operation window 390 having been shifted in display position. FIG. 5B shows that the name of “Nayama Hiromichi” displayed at the third position from the top of operation window 390 in FIG. 5B is selected. That is, the display position of operation window 390 on display unit 30 is shifted from the state shown in FIG. 5A to that shown in FIG. 5B. The user can drag the top of operation window 390 closer to the user's hand (finger) as shown in FIG. 5B such that the name (selected site) displayed in an upper portion of operation window 390 which is not accessible by the finger in the state shown in FIG. 5A can be displayed at a position directly accessible by the hand (finger).

It is to be noted that, with the display position of operation window 390 shifted, a portion underlying operation window 390 in FIG. 5A becomes visible to the user in an upper portion of display unit 30, as shown in FIG. 5B. A visible background may have various patterns depending on the activation state of the application and the type of operation window displayed on display unit 30. In the case where the headers of the address book, that is, the highest-level operation window for operating the application (the highest-level operation window for operating the application) constitute the operation window, a portion underlying the address book becomes visible as the background. Alternatively, headers belonging to the row of “ta” overlapping the row of “na” may be partially displayed. In the case where the operation window displayed on display unit 30 is the operation window of the address-book application itself, a wallpaper or an application other than the address book is visible as the background. In this case, a window displayed as the wallpaper is visible as the background when no other application is activated in parallel in mobile phone 100. In the case where another application is activated in parallel and operation window 390 is displayed at the forefront in the state shown in FIG. 5A, the window of the other application activated in parallel becomes visible as the background in the state shown in FIG. 5B.

Although FIGS. 5A and 5B illustrate the window displaying information related to the address-book application to exemplify a dragged window, the window in which the display position can be dragged in this manner is not limited to such window in mobile phone 100. Such window further includes a window displaying various types of contents such as maps or Web contents, a window reproducing and allowing browse of downloaded video, music or the like, a window for creating or displaying an e-mail, a window allowing for item selection from a list of a plurality of selection items, and particularly, a window on which a click operation (a touch on touch panel 40) is performed for some subsequent operation in mobile phone 100.

Another example of a dragged window will now be described illustrating a Web contents browser window. It is to be noted that the Web contents browser window involves reproducing contents and displaying items linked to URL (Uniform Resource Locator) addresses of other homepages. A selection is made from among (character strings corresponding to) the items by a single tap or the like, so that processing such as accessing a link corresponding to a selected item is executed. From such points of view, the Web contents browser window is also regarded as an operation window in which information for causing mobile phone 100 to execute processing is input.

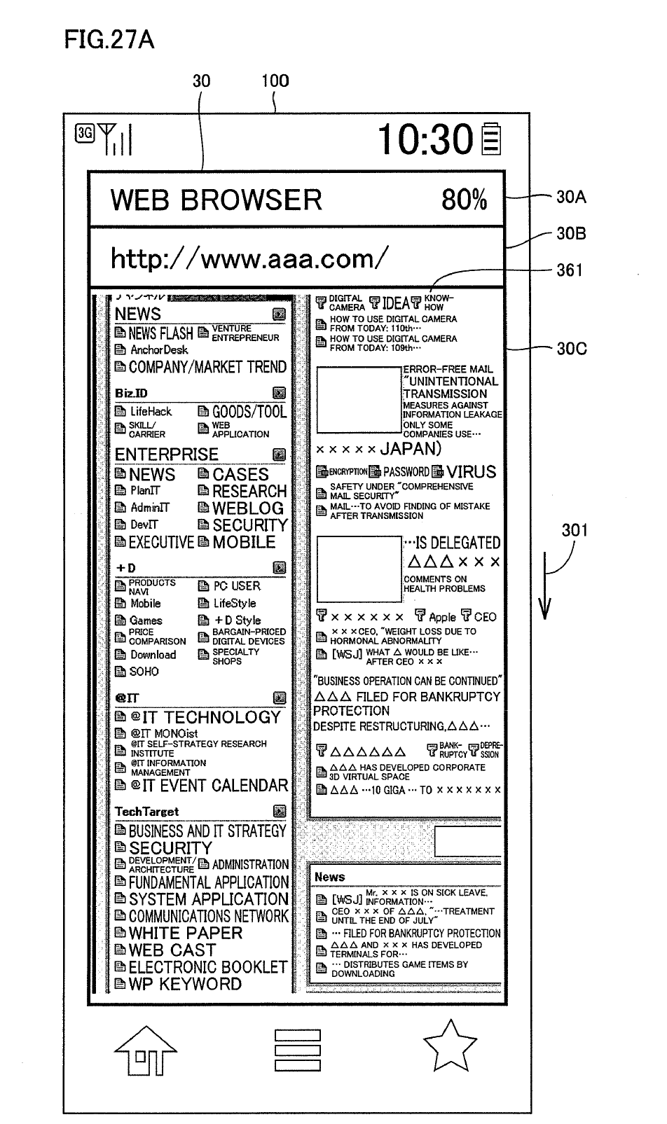

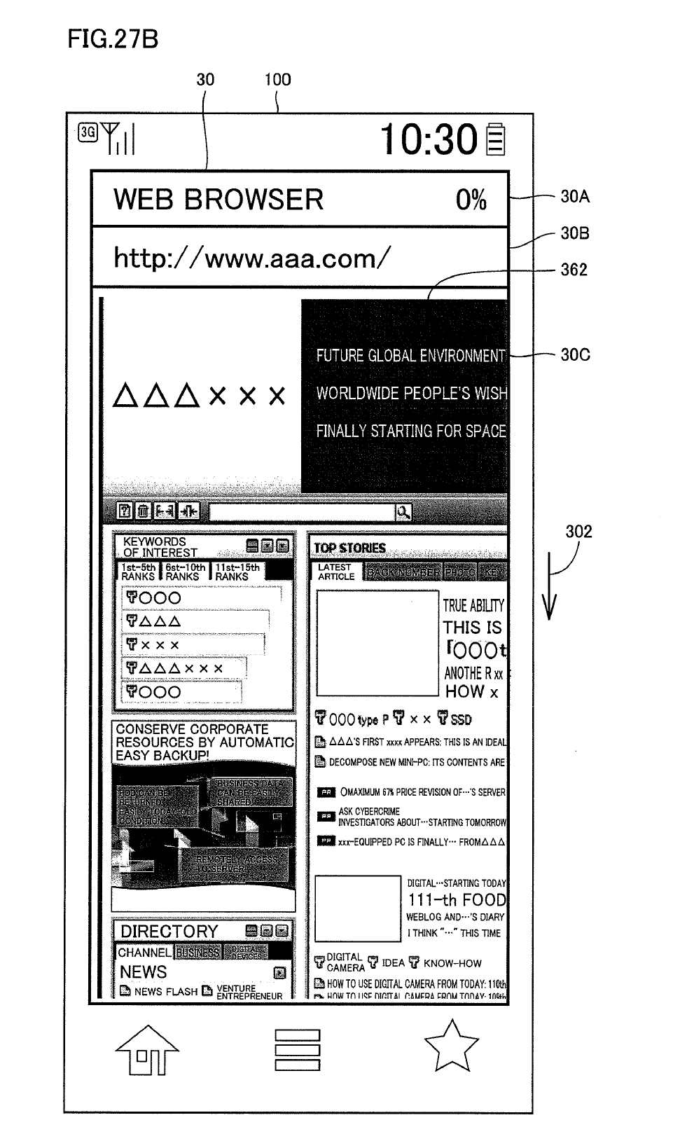

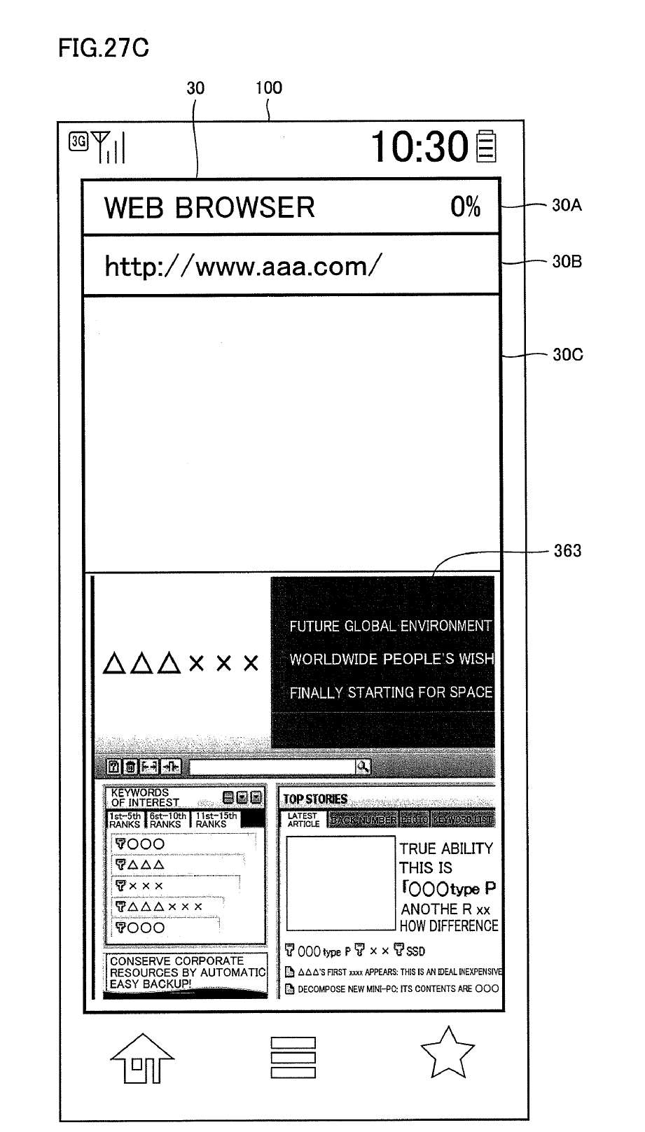

FIGS. 27A to 27C explain a mode in which a Web contents browser window displayed on display unit 30 is dragged.

First, with reference to FIG. 27A, a window including a Web contents browser window is displayed on display unit 30. A Web browser window includes a display box 30A displaying information specifying an application for displaying the browser window (in FIG. 27A, textual information of “Web browser”) or the like, a display box 30C displaying a Web contents browser window 361, and a display box 30B displaying the URL address (the URL address mobile phone 100 is accessing through the Web browser) at which the Web contents displayed in display box 30C reside.

The Web browser, installed in mobile phone 100, is executed so that the Web contents browser window as shown in FIG. 27A is displayed. The window displayed in display box 30C corresponds to an operation window for input of information for use in Web browser-related processing by a touch operation or the like. It is to be noted that a portion of the Web contents is displayed in display box 30C.

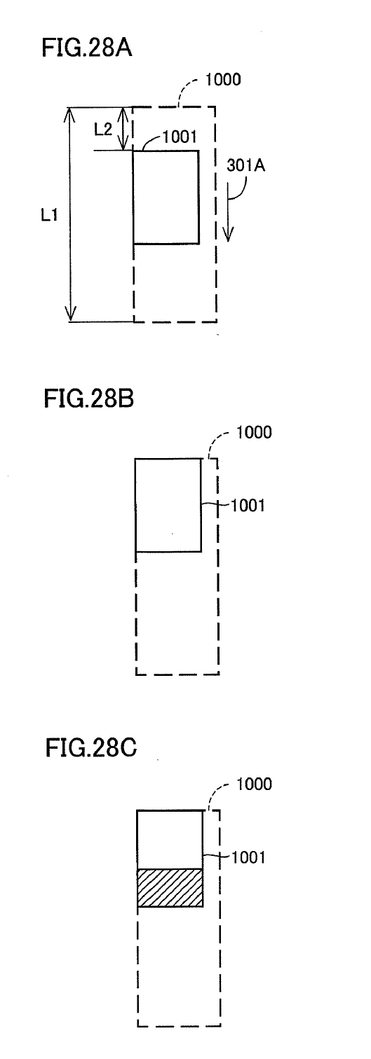

FIG. 28A schematically shows the relationship between a virtual window of the entire Web contents and a portion thereof displayed in display box 30C.

With reference to FIG. 28A, an image of an area denoted as a portion 1001 of Web contents 1000 indicated by broken lines is displayed in display box 30C. The portion of Web contents 1000 displayed in display box 30C is changed in relative position and size in Web contents 1000 (a display scale in display box 30C) based on, for example, details of an operation performed on touch panel 40.

Referring back to FIG. 27A, the Web contents displayed in display box 30C include a plurality of items having link information such as URL addresses and the like. For example, in the Web contents, four items (“News Flash”, “Venture Entrepreneur”, “Anchor Desk”, and “Company/Market Trend”) displayed in the group of “News” in the upper portion in the left column of display box 30C shall be linked to URL addresses, respectively. In this case, when the user performs a touch-and-release or the like on characters of each item, the Web browser accesses a URL address linked to the item.

Information indicative of the relative position of the portion displayed in display box 30C with respect to the entire Web contents is displayed in display box 30A, in addition to information specifying an application (Web browser) being executed.

The information of “80%” in display box 30A shown in FIG. 27A indicates how much display information remains above the portion displayed in display box 30C in the entire Web contents.

More specifically, a calculation is made according to the following expression (1) using L1 and L2 shown in FIG. 28A, for example:

R%=(L2/L1)×100 (1)

Herein, L1 represents the longitudinal dimension of the entire Web contents (the longitudinal dimension of entire Web contents 1000), and L2 represents the distance between the upper end of the portion displayed in display box 30C and the upper end of the Web contents (the distance between the upper ends of portion 1001 and Web contents 1000). Information displayed in display box 30A is denoted by R %. With such information displayed in display box 30A, the user can readily identify at which position the information displayed in display box 30C resides in the entire Web contents.

It is to be noted that the display for allowing users to identify such proportion is not limited to the display in percentage as shown in FIG. 27A and the like. Information indicating the positional relationship itself between the entire contents and the portion displayed in display box 30C may be displayed on display unit 30 independently of window 361 as schematically shown in FIG. 28A, provided that the information allows users to identify the positional relationship of the window displayed in display box 30C relative to an end of the contents.

When the user performs an operation (e.g., drag) on touch panel 40 in such a manner as to slide downwardly as indicated by an arrow 301 starting from the state shown in FIG. 27A, the display window in display box 30C is scrolled downwardly by an amount corresponding to the amount of the operation (the distance and the number of finger sliding operations) according to the menu drag process, and then the scroll is stopped so that a stationary window at the stopped position is displayed.

This scrolling may be performed in such a manner that the window has inertia. In this case, the scrolling speed is gradually increased after the start of scrolling, and then decreased to stop the scrolling.

FIG. 28A shows an arrow 301A. The directional relationship between arrow 301A and Web contents 1001 corresponds to that between arrow 301 and window 361 shown in FIG. 27A.

When a finger is slid downwardly on touch panel 40 as described above, portion 1001 of Web contents 1000 displayed in display box 30C is changed from that shown in FIG. 28A to that shown in FIG. 28B.

When the finger is slid on touch panel 40, Web contents 1000 is shifted relative to portion 1001 in the direction that the finger is slid (the direction of arrow 301A in FIG. 28A). That is, consequently, the relative positional relationship between Web contents 1000 and portion 1001 changes in such a manner that portion 1001 is shifted in Web contents 1000 in the opposite direction of arrow 301A (upwardly), as shown in FIG. 28B.

FIG. 27B shows a window displayed on display unit 30 as a result of sliding the finger in the direction of arrow 301. In FIG. 27B, the window displayed in display box 30C is changed to a window 362.

In FIG. 27B, the portion of the entire Web contents displayed in display box 30C is changed as shown in FIG. 28B from that of FIG. 28A in positional relationship between the upper ends of Web contents 1000 and portion 1001, so that the percentage indication displayed in display box 30C is changed accordingly. More specifically, in FIG. 27B, the upper end of the Web contents is shown at the upper end of display box 30C. Above-mentioned distance L2 is accordingly reduced to zero, so that “0%” is displayed in display box 30A.

When the user's finger is further slid on touch panel 40 downwardly as indicated by an arrow 302 from the state shown in FIG. 27B, the display in display box 30C is changed as shown in FIG. 27C such that window 362 itself of the Web contents displayed in display box 30C shifts downwardly (arrow 302). The display having been changed is shown in FIG. 27C.

In FIG. 27C, the upper end of a window 363 of the Web contents displayed in display box 30C does not coincide with and is located below the upper end of display box 30C. The portion of the Web contents displayed in display box 30C is therefore reduced in longitudinal dimension. More specifically, as shown as portion 1001 in FIG. 28C, a hatched lower portion is removed from portion 1001 shown in FIG. 28B.

When an item in window 363 (e.g., each of the items of “1st-5th ranks”, “6th-10th ranks”, and “11th-15th ranks” shown as tabs in the menu of “Keywords of interest”) is operated in a pattern different from sliding the user's finger on touch panel 40 (e.g., a touch-and-release on touch panel 40), the Web browser, determining that information corresponding to an operated item has been input, executes processing such as changing the display contents in window 363.

According to the example of window dragging described above with reference to FIGS. 27A to 27C, a selected item located near the top of Web contents (e.g., each of the above-mentioned items of “1st-5th ranks”, “6th-10th ranks”, and “11th-15th ranks” in the “Keywords of interest” menu) can be displayed slightly below the center of display box 30C in the longitudinal direction, as shown in FIG. 27C. This allows the user to select from among items located near the top (upper end) of a page of the Web contents by a finger of one hand while holding mobile phone 100 by that hand.

In this manner, after shifting the display position of the operation window on display unit 30 further in the shift direction relative to an end of the operation window, the operation window is continuously displayed at the display position having been shifted, so that the user can select from among selection items by a touch-and-release or the like on the operation window at the shifted display position.

It is to be noted that, although the above description is made with the upper end of Web contents being displayed in display box 30C, the drag operation can also be operated similarly with the lower, right side or left side end of Web contents being displayed.

Referring back to FIGS. 5A and 5B, when a determination is made at step S216 that the shift distance does not exceed the certain threshold value, the user operation is identified as a selection of a menu item (a selected site, such as a button, in operation window 31) (steps S218 to S220), and when a determination is made that the shift distance exceeds the certain threshold value, the user operation is identified as an operation for shifting the display position of operation window 31 in a dragging manner (steps S224 to S226). Herein, the threshold value of the shift distance can also be determined automatically depending on the size of and the distance between the buttons in the operation window. The method of determining the threshold value will be described later.

Herein, the shift distance may be an actual shift distance of an operation target position on touch panel 40, or may be a shift distance in a certain direction.

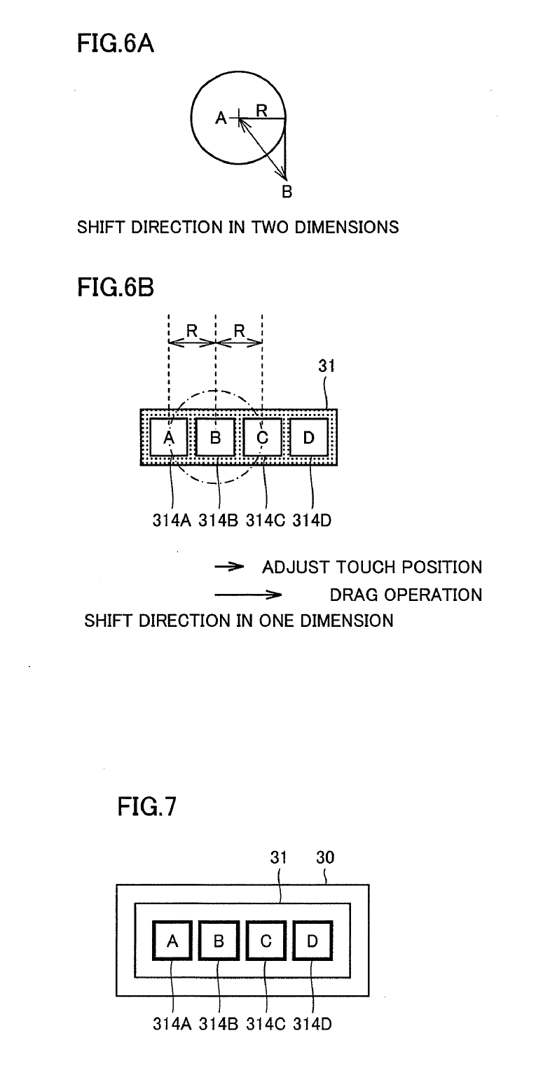

More specifically, when the operation target position is shifted from a point A to a point B as shown in FIG. 6A, the shift distance may be the direct distance from point A to point B, or may be the distance of a horizontal component (distance RX) in the shift from point A to point B.

Then, as shown in FIG. 6B, buttons 314A to 314D are displayed in operation window 31. Representing the horizontal distance between the central positions of adjacent buttons by R, the threshold value of the shift distance can be set at this distance R.

In this manner, the threshold value is set at distance R between the central positions of adjacent buttons, so that the threshold value can be determined depending on the size of and the distance between the buttons in the operation window. Determining the threshold value per operation window enables a more precise distinction between the menu selection mode and the drag mode irrespective of the size of and the distance between the buttons.

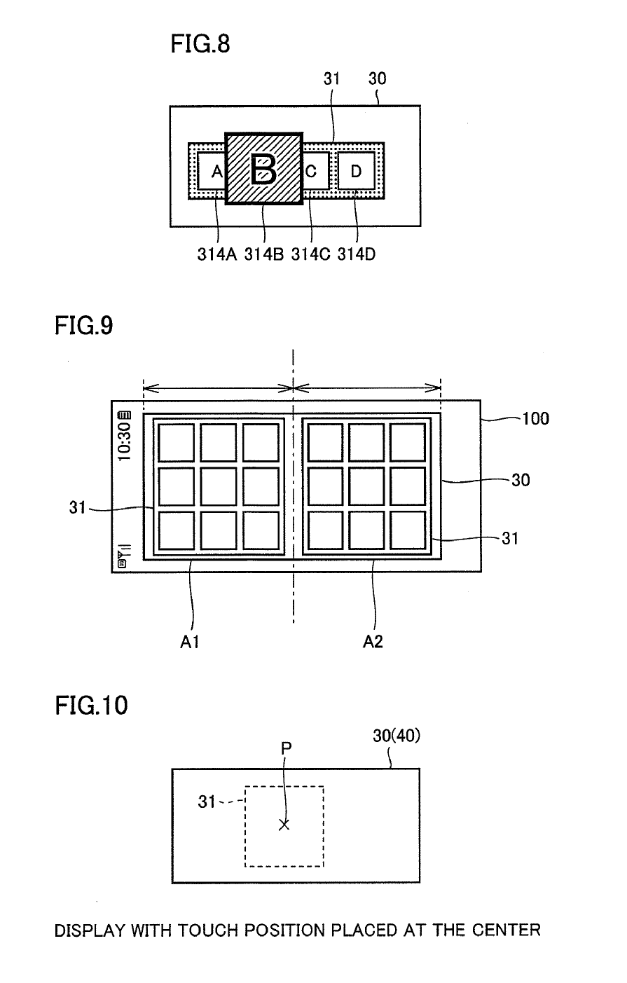

When a drag operation is performed on operation window 31 (menu) at least in the horizontal direction by a distance longer than or equal to distance R, the display position of operation window 31 (operation window 390) on display unit 31 is shifted by steps S216 and S222 to 226. The mobile phone is in the menu selection mode when a drag operation is not performed on operation window 31 on display unit 30 (an area of touch panel 40 corresponding to operation window 31) as shown in FIG. 7, or when a distance shifted by a drag operation, if any, is shorter than distance R. Then, the closest button to the current operation position is highlighted through steps S216 to 220. FIG. 8 shows button 314B in operation window 31 being highlighted, as an example of button highlighting.

At step S218, the CPU specifies the operation button at the closest position to the touch position in operation window 31, and advances the process into step S220.

At step S220, the CPU highlights the button specified at step S220, and terminates the menu drag process. This button highlighting enables the user to readily identify the selected item and to readily identify that mobile phone 100 is in the menu selection mode. When highlighting occurs during a touch operation for the purpose of dragging, the user can identify that the drag distance is too short to drag and display operation window 31, and then continues performing a drag operation by a longer distance to cause mobile phone 100 to shift the display position of operation window 31 in a dragged manner.

With reference to FIG. 19, at step S228, the CPU determines whether or not the mobile phone is in the menu selection mode. When a YES determination is made, the process proceeds into step S230, and when a NO determination is made, the process proceeds into step S232.

At step S230, the CPU executes processing corresponding to the menu item currently selected in mobile phone 100, and then advances the process into step S234.

At step S232, the CPU determines whether or not the mode of mobile phone 100 is the drag mode. When a YES determination is made, the process proceeds into step S234, and when a NO determination is made, the menu drag process is terminated (with the menu (operation window 31) being displayed).

At step S234, the CPU changes the mode of mobile phone 100 to the menu display mode, and terminates the menu drag process.

The contents displayed on display unit 30 in FIGS. 4A and 4B will now be described in association with the procedures in accordance with the flow charts shown in FIGS. 18 and 19.

Just after the user's finger touches operation window 31 as shown in FIG. 4A, the process advances from steps S202 to S208, so that touch start position P0 and touch start time T0 are stored. Then, the mode of the mobile phone is changed to the menu selection mode at step S210, and a determination is made at step S216.

If the finger is not shifted or the shift distance is too short to exceed the above-described certain threshold value, a NO determination is made at step S216. The process then proceeds into step S218 (FIG. 18), where the closest button (button 311B shown in FIG. 4A) to the current touch position is selected. It is to be noted that the button having been selected may be highlighted at step S220, or highlighting at step S220 may not be performed. The process is then returned to step S202.

During a period in which the user touches touch panel 40 continuously in a shift operation of shifting his/her finger in the direction indicated by A31, from the state shown in FIG. 4A to the state indicated by broken lines H1 in FIG. 4B, the mode of mobile phone 100 is changed to the drag mode at step S222, and then a series of steps S202, S204, S212, S214, S224, and S226 is repeated until the user stops his/her finger, so that the menu display position is shifted with the finger shift. More specifically, when the shift distance of the user's finger on the touch panel by the shift operation exceeds the above-mentioned certain threshold value, a YES determination is made at step S216 to advance the process into step S222, where the operation mode of mobile phone 100 is changed to the drag mode. Then, a series of steps S202, S204, S212, S214, S224, and S226 is repeated, so that the menu display position is shifted.

When the user lifts his/her finger off touch panel 40 at the position indicated by H1 (FIG. 4B) (i.e., when a touch-and-release is performed at that position), a NO determination is made at step S202 to advance the process into step S228 in FIG. 19. At this time point, the operation mode of mobile phone 100 is the drag mode. The process therefore proceeds into step S232 and then step S234, where the operation mode of mobile phone 100 is changed to the menu display mode, following which the process is returned to step S202. At this stage, the display position of operation window 31 remains at the shifted position by the execution of step S226 until then, that is, remains in the state shown in FIG. 4B.

Once the user performs a touch-and-release after the shift operation, and then touches the position indicated by H2 in FIG. 4B by his/her finger, the process is started from step S202. Then, steps S204, S206, S208, and S210 are sequentially executed. The operation mode of mobile phone 100 is thereby changed to the menu selection mode. Then, at S218, a button (button 311A shown in FIG. 4B) located proximate to the touch position is selected, and the process is returned to step S202.

When the user lifts his/her finger off touch panel 40 at the position indicated by H2 (i.e., when the shift distance is shorter than the threshold value at step S216, and a touch-and-release occurs in the menu selection mode), the process proceeds from step S202 to S228. Because the operation mode of mobile phone 100 has not bee changed from the menu selection mode after the touch operation is performed at the position of H2, a YES determination is made at step S228, and the process proceeds into step S230. At step S230, the selected menu item, that is, processing corresponding to button 311A shown in FIG. 4B is executed. After the processing is executed, the operation mode of mobile phone 100 is changed to the menu display mode at step S234, and the process is returned to step S202.

In the above-described menu drag process, the display position of operation window 31 having been shifted is centered at the end point of the user's drag operation on touch panel 40.

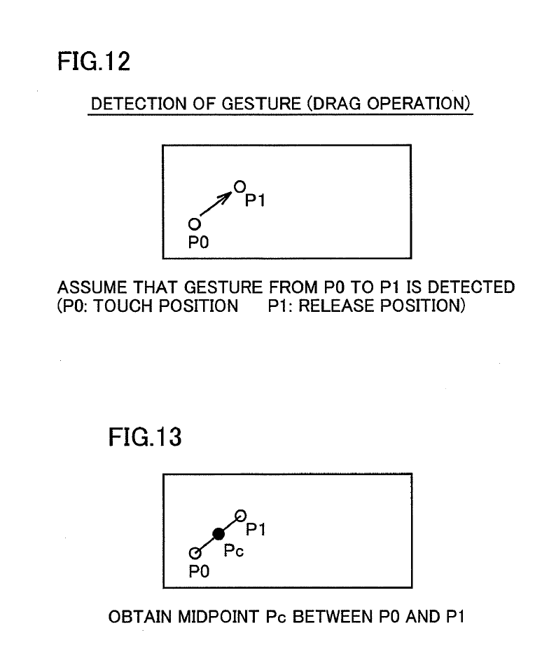

For example, when a drag operation is performed from point P0 to point P1 on touch panel 40 as shown in FIG. 12, the display position of operation window 31 having been shifted is centered at point P1.

Alternatively, as shown in FIG. 13, the display position of operation window 31 having been shifted may be centered at the midpoint (a point Pc) between point P0 at which the drag operation is started and point P1 at which the drag operation is finished (where the user lifts his/her finger off touch panel 40).

If operation window 31 cannot be displayed entirely on display unit 30 even when the user wishes to display operation window 31 on display unit 30 with point Pc placed at the center, point Pc is preferably corrected as appropriate (as described with reference to FIGS. 11A and 11B, for example).

In the above-described menu drag process, when the shift distance is longer than or equal to the certain distance at step S216, the mode of shift operation window 31 in accordance with a user operation on touch panel 40, that is, the drag mode is brought about.

In the above description, the shift distance in a touch operation is used as a requirement for bringing about the drag mode, however, other operation modes may also be requirements for bringing about the drag mode. An accurate determination whether to bring about the drag mode based on a user operation is important, because the need arises to determine whether to execute an executable selection item such as a button, if any, at the touch position or whether to shift the operation window without executing the item.

Providing a mobile phone with determination means for determining whether to bring about the drag mode based on a user operation or whether to select a menu corresponding to the touch position will allow a touch-panel-equipped device having a small display window to exert advantageous effects in terms of design of operation window and usability.

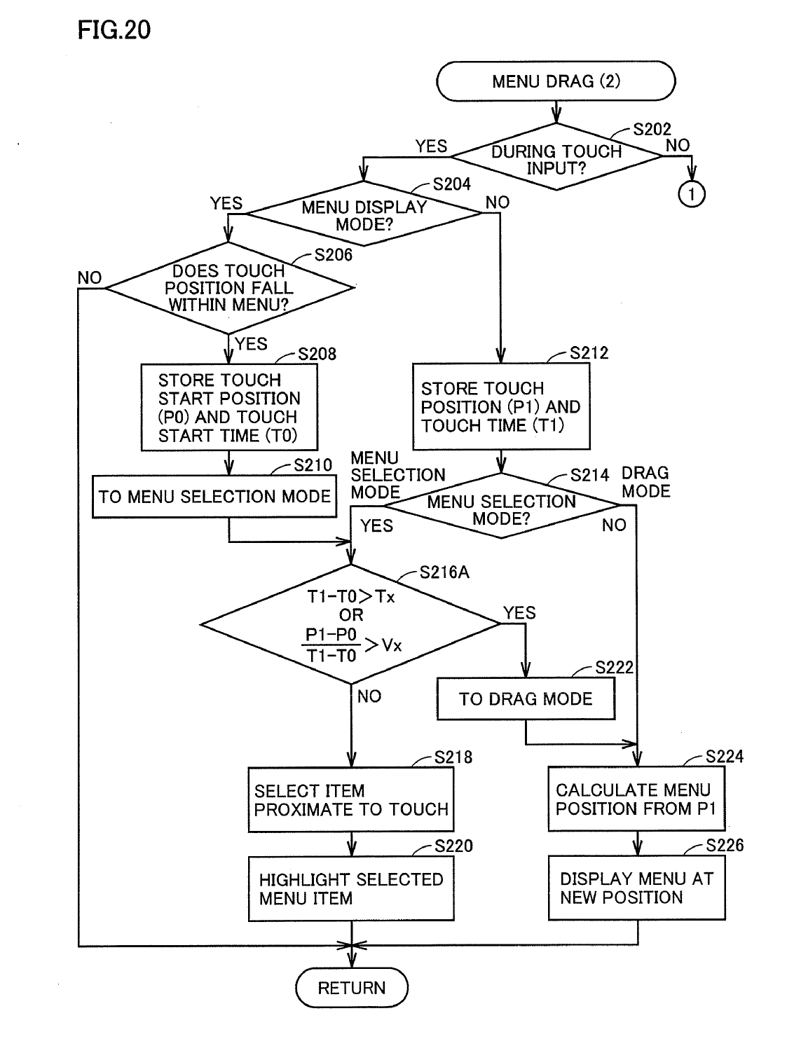

It is to be noted that, instead of the shift distance of a user operated position, mobile phone 100 may be configured to be changed to the drag mode provided that the user operates touch panel 40 without making any touch-and-release for a somewhat long time period or provided that the user performs a drag operation by shifting his/her finger over operation window 31 at a speed greater than or equal to a certain speed. An example of such processing is shown in FIG. 20.

FIG. 20 corresponds to a flow chart of a variation of the flow chart of FIG. 18.

In FIG. 20, step S216 in FIG. 18 is replaced by step S216A.

At step S216A, a determination is made whether or not the difference between touch start time T0 and touch time T1 (T1−T0), that is, a time period during which a touch operation continues exceeds a predetermined threshold value Tx, or whether or not the shift speed, that is, a value obtained by dividing the shift distance (P1−P0) by the shift time (T1−T0) (shift speed (herein, an initial speed of shifting)) exceeds a predetermined threshold value Vx. Mobile phone 100 is configured to be changed to the drag mode when the time period during which a touch operation continues exceeds predetermined threshold value Tx or when the shift speed exceeds threshold value Vx. Continuation of a touch operation refers to a state of being kept touched without any touch-and-release after the touch.

Mobile phone 100 may also be configured to be changed to the above-described drag mode provided that a user operation corresponds to a reciprocating motion.

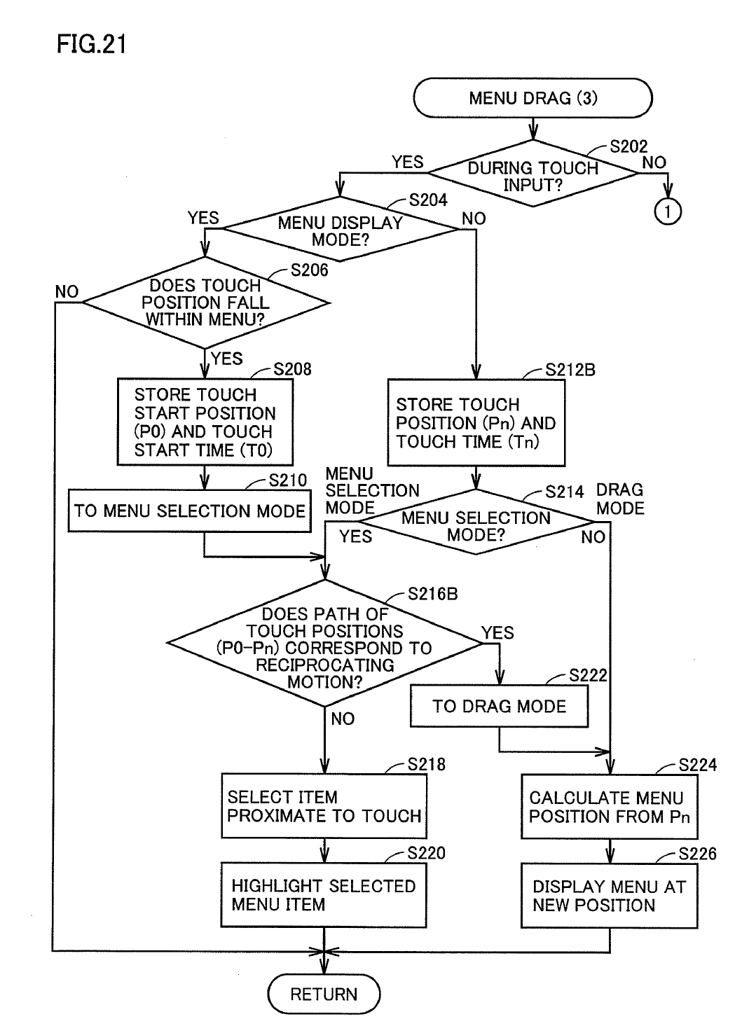

FIG. 21 shows a flow chart of such a variation.

In FIG. 21, touch positions (Pn) are successively stored in the touch information storage table at step S212B until the menu display mode is brought about. At step S216B, a determination is made whether or not the path analyzed from a series of touch positions Pn corresponds to a reciprocating motion. In the case of a reciprocating motion, mobile phone 100 is brought into the drag mode at step S222.

Mobile phone 100 may also be configured to be changed to the above-described drag mode based on the position at which the user operates touch panel 40.

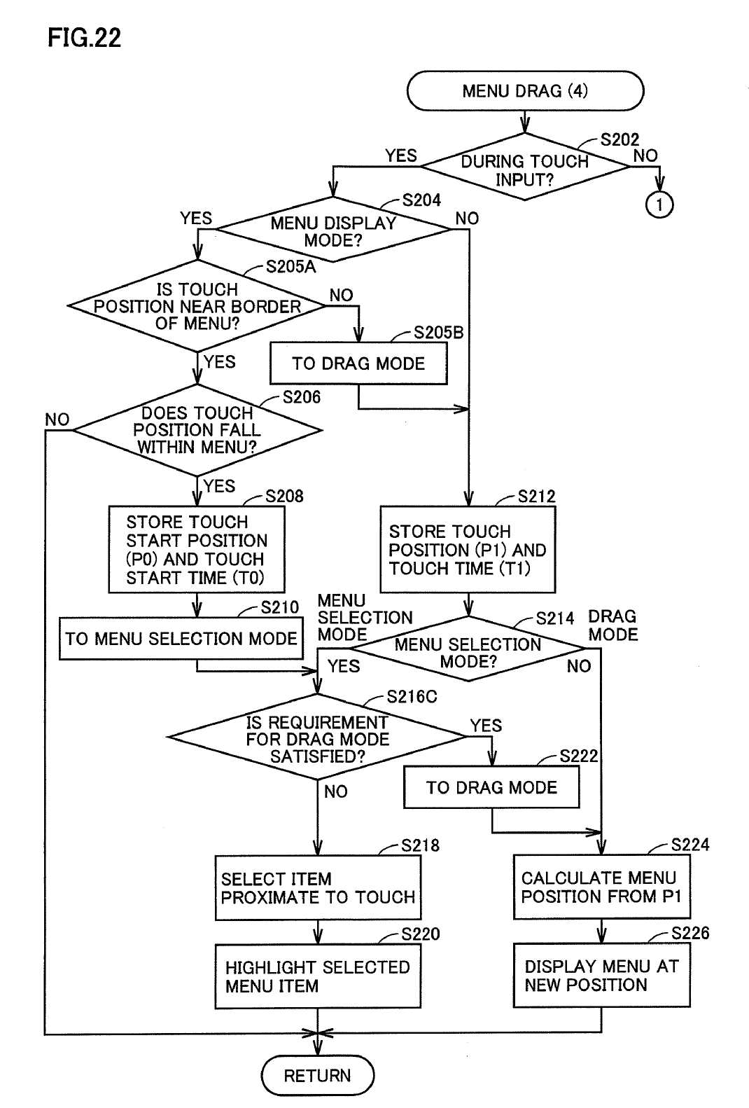

FIG. 22 shows a flow chart of such a variation.

With reference to FIG. 22, when a determination is made at step S204 that mobile phone 100 is in the menu display mode, then, a determination is made at step S205A whether or not the user's touch position is proximate to an end of operation window 31 (near the border of the menu).

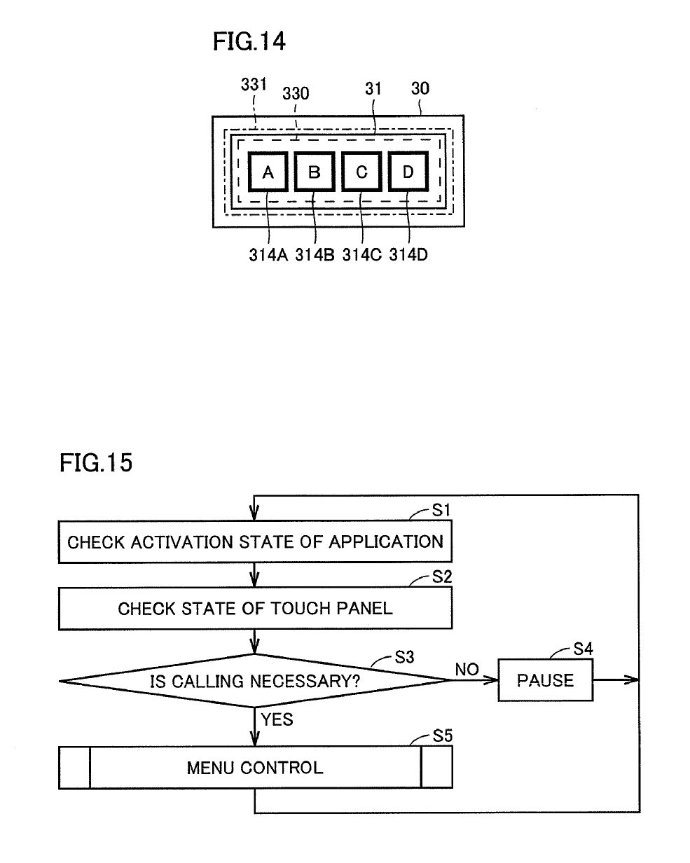

It is to be noted that located proximate to an end is an area defined by broken lines 330 and long and short dashed lines 331, as shown in FIG. 14, for example. This area can be an area outside buttons 314A to 314D provided in operation window 31.

When a determination is made at step S205A that the touch position is proximate to the end, then, the mode of mobile phone 100 is changed to the drag mode at step S205B. It is to be noted that, at step S205A, when the touch position is in an area other than the area where the buttons (selection items) are displayed in the operation window, the process may proceed into step S205B.

Mobile phone 100 may also be configured to be changed to the above-described drag mode provided that a certain type of touch operation is performed.

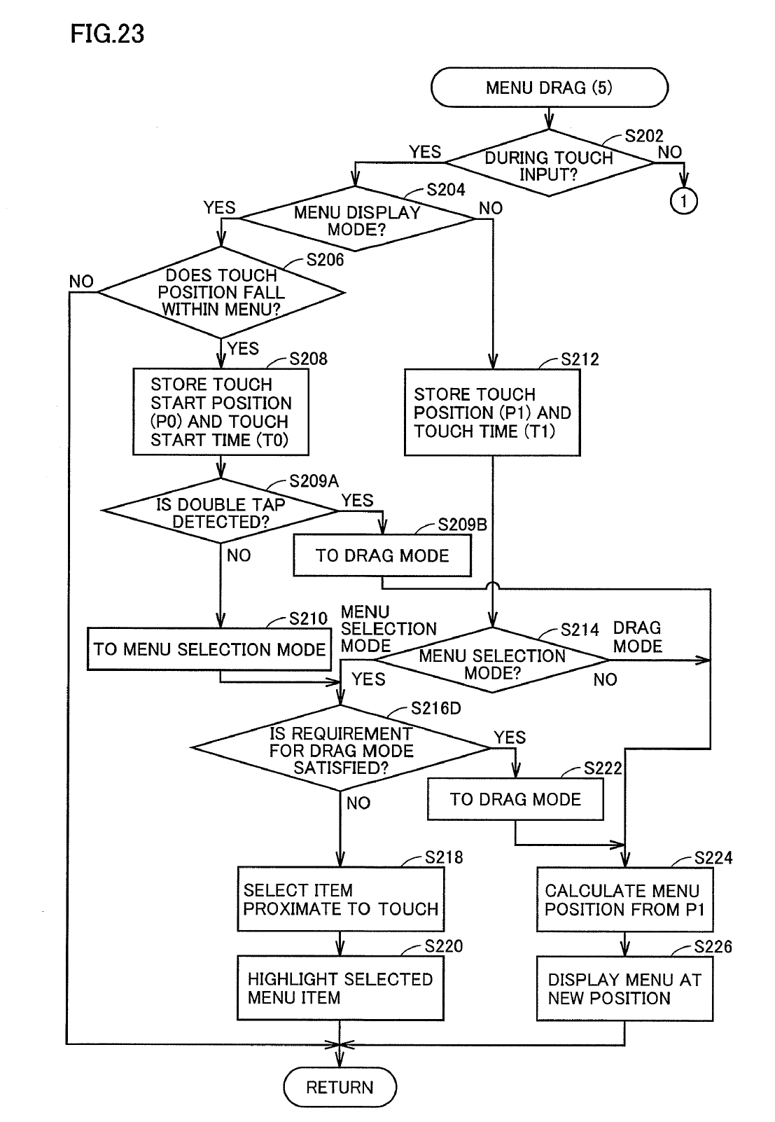

FIG. 23 shows a flow chart of such a variation.

With reference to FIG. 23, after touch start position (P0) and touch start time (T0) are stored at step S208, a determination is made at step S209A whether or not the type of touch operation currently performed on touch panel 40 is a double touch, with reference to Table 3. When a NO determination is made, the mode of mobile phone 100 is changed to the drag mode at step S209B.

A menu-position return process of returning the position of a dragged menu will now be described.

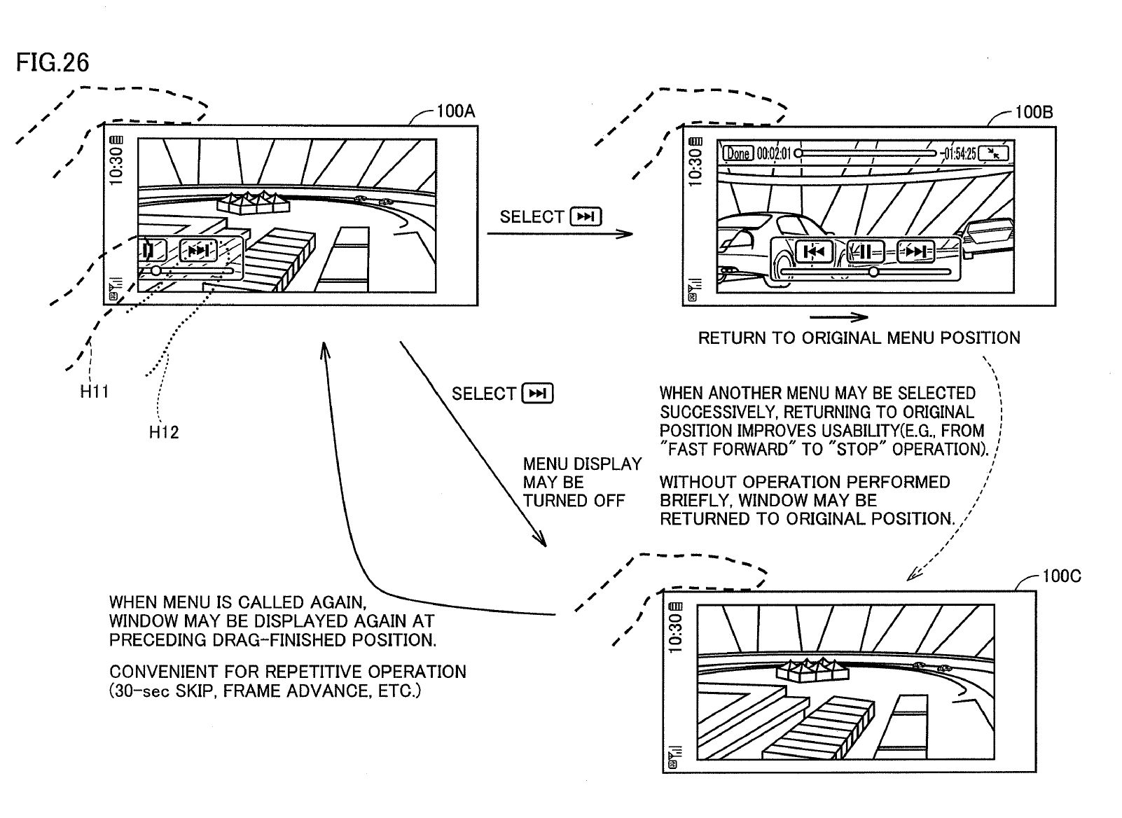

As shown in FIG. 26, mobile phone 100 executes processing such that, after a button in operation window 31 displayed on display unit 30 is operated, operation window 31 is returned to the display position before the button is operated.

More specifically, after the display position of the operation window is shifted such that the operation window is dragged closer to the user's finger in accordance with a user operation on touch panel 40, a touch-and-release occurs at a position indicated by broken lines H11, as shown as mobile phone 100B in FIG. 26. The user's finger then selects a button 311 in operation window 31 at a position indicated by dotted lines H12. After the processing is executed, the menu-position return process is executed such that the display position of operation window 31 on display unit 30 is returned to its original position, as shown as mobile phone 100A in FIG. 26.

The menu-position return process may be such that the display position is returned to its original position when any new touch operation is not performed for a certain time period after the drag operation is finished. In other words, the display position may also be returned to its original position when processing for a second operation on the operation window, such as a selection, is not executed. Alternatively, without any new touch operation performed briefly, the operation window may no longer be displayed, as shown as mobile phone 100C in FIG. 26.

As shown in FIG. 26, mobile phone 100 executes processing such that, after a button in operation window 31 displayed on display unit 30 is operated, operation window 31 is returned to the display position before the button is operated. More specifically, as shown in mobile phone 100A in FIG. 26, the window is dragged closer to the user's finger (broken lines H11) in accordance with a user operation on touch panel 40, and then the user selects button 311 in operation window 31. In response to the selection, the menu-position return process is executed such that the display position of operation window 31 on display unit 30 is returned to its original position, as shown as mobile phone 100B in FIG. 26.

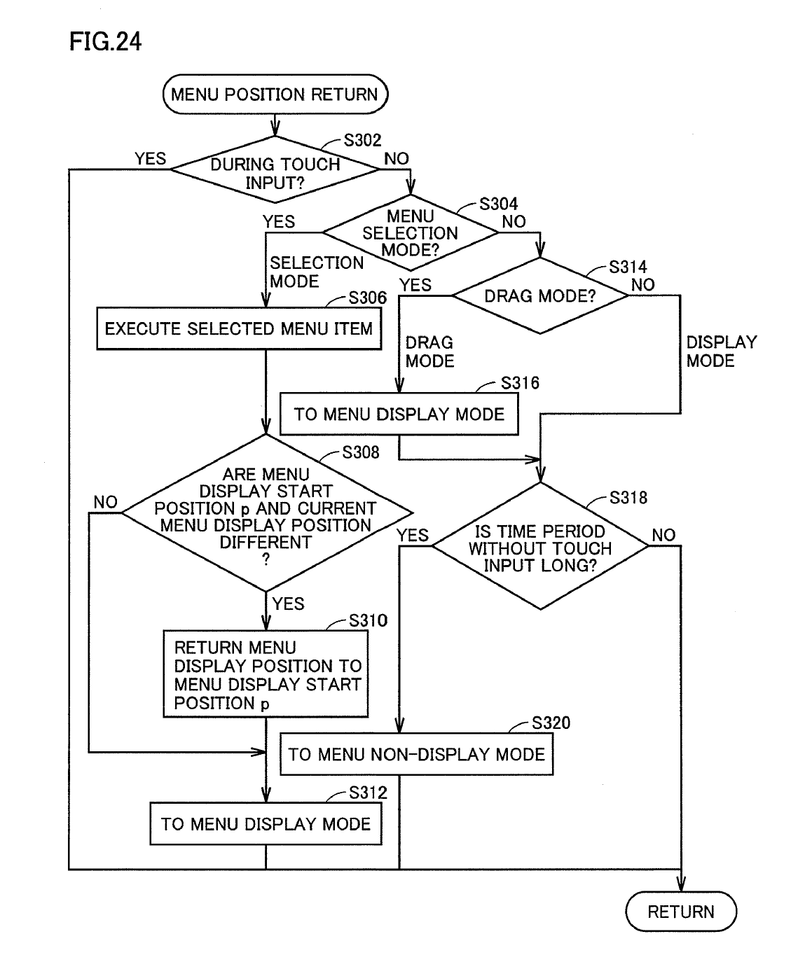

FIG. 24 is a flow chart of the menu-position return process.

With reference to FIG. 24, in the menu-position return process, at step S302, the CPU first determines whether or not the mode of mobile phone 100 is the menu selection mode. When a YES determination is made, the process proceeds into step S306, and when a NO determination is made, the process proceeds into step S314.

At step S306, the CPU executes a processing item selected by the user operating a button (e.g., button 311) in operation window 31, and advances the process into step S308.

At step S308, the CPU determines whether menu start position p (see Table 4) and the current menu display position (the central coordinates of operation window 31) are different from each other. When a YES determination is made, the process proceeds into step S310, and when a NO determination is made, that is, when a determination is made that the central coordinates of current operation window 31 coincide with the coordinates stored as display start position p, the process proceeds into step S312.

At step S310, the CPU shifts (returns) the display position of operation window 31 such that its central coordinates coincide with the coordinates stored as display start position p, and advances the process into step S312.

At step S312, the CPU changes the mode of mobile phone 100 to the menu display mode, and terminates the menu-position return process.

At step S314, the CPU determines whether or not the mode of mobile phone 100 is the drag mode. When a YES determination is made, the process proceeds into step S316, and when a NO determination is made, the process proceeds into step S318.

At step S316, the CPU changes the mode of mobile phone 100 to the menu display mode, and advances the process into step S318.

At step S318, the CPU determines whether or not a time period without any touch input continues for a predetermined certain time period Tx or longer. When a YES determination is made, the process proceeds into step S320, and when a NO determination is made, the menu-position return process is terminated.

At step S320, the CPU changes the mode of mobile phone 100 to the menu non-display mode, and terminates the menu-position return process.

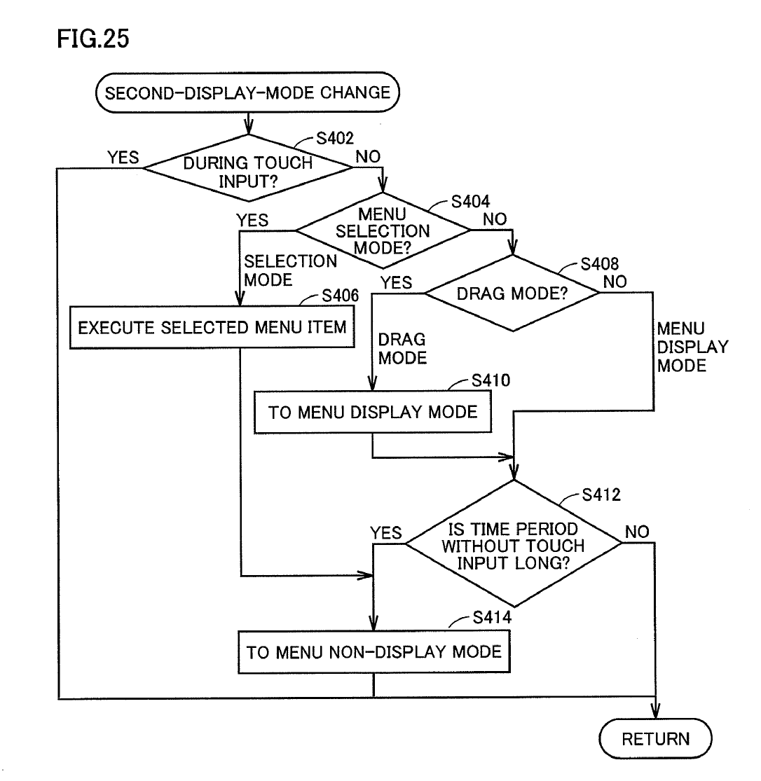

The second-display-mode change process will now be described with reference to the flow chart of the process shown in FIG. 25.

With reference to FIG. 25, in the second-display-mode change process, the CPU first determines at step S402 whether or not an input operation is performed on touch panel 40. When a YES determination is made, the second-display-mode change process is terminated. When a determination is made that no touch operation is performed currently, the CPU advances the process into step S404.

At step S404, the CPU determines whether or not the mode of mobile phone 100 is the menu selection mode. When a YES determination is made, the process proceeds into step S406, and when a NO determination is made, the process proceeds into step S408.

At step S406, the CPU executes a control item selected currently, and advances the process into step S414.

At step S408, the CPU determines whether or not mobile phone 100 is in the drag mode. When a YES determination is made, the process proceeds into step S410, and when a NO determination is made, the process proceeds into step S412.

At step S410, the CPU changes the mode of mobile phone 100 to the menu display mode, and advances the process into step S412.

At step S412, similarly to step S318, the CPU determines whether or not a time period without any touch input on touch panel 40 is longer than or equal to time period Tx stored in setting details storage unit 62, for example. When a YES determination is made, the process proceeds into step S414, and when a NO determination is made, the second-display-mode change process is terminated.

At step S414, the CPU changes the mode of mobile phone 100 to the menu non-display mode, and terminates the second-display-mode change process.

It should be understood that the embodiments disclosed herein are illustrative and non-restrictive in every respect. The scope of the present invention is defined by the claims, not by the description above, and is intended to include any modification within the meaning and scope equivalent to the claims.

### DESCRIPTION OF THE REFERENCE SIGNS

30 display unit; 31, 390 operation windows; 40 touch panel; 50 controller; 50A timer; 51 display control unit; 53 to 55 audio output control units; 56 receiver; 57 speaker; 58 microphone; 60 storage unit; 61 program storage unit; 62 setting details storage unit; 63 data storage unit; 80 communication control unit; 81 antenna; 90 attitude detection unit; 100 mobile phone; 310, 311 buttons.

1-25. (canceled)

26. A mobile information terminal comprising:
a display unit;
a touch panel arranged in said display unit;
an execution unit executing an application; and
a display controller controlling display of said display unit in accordance with an operation on said touch panel, wherein
said display controller displays, on said display unit, an operation window,
said operation window includes items,
said execution unit executes processing related to said application corresponding to said items, in accordance with a touch operation of selecting from among said items on said operation window, and
said display controller shifts a display position of said operation window in accordance with that a position at which the operation on said touch panel is started falls within a display area of said operation window and that the operation on said touch panel is a first operation satisfying a predetermined requirement.

27. The mobile information terminal according to claim 26, wherein
said display controller displays, in said operation window, items for input of information for use in the processing related to said application, and
when determining that said predetermined requirement is not satisfied with the operation performed on said touch panel, said display controller highlights one of said items in said operation window that is closest to an operation position on said touch panel.

28. The mobile information terminal according to claim 26, wherein said display controller determines whether or not said predetermined requirement is satisfied based on a shift distance of an operation position on said touch panel.

29. The mobile information terminal according to claim 28, wherein
said display controller displays, in said operation window, items for input of information for use in the processing related to said application, and
a threshold value of said shift distance for determining whether or not said predetermined requirement is satisfied is determined based on a display size of said items and a display interval between said items in said operation window.

30. The mobile information terminal according to claim 26, wherein said display controller determines whether or not said predetermined requirement is satisfied based on an operation pattern on said touch panel.

31. The mobile information terminal according to claim 26, wherein said display controller determines whether or not said predetermined requirement is satisfied based on a magnitude of acceleration of a shift from an operation position at which the operation on said touch panel is started.

32. The mobile information terminal according to claim 26, wherein said display controller determines whether or not said predetermined requirement is satisfied based on a time period during which the operation on said touch panel continues.

33. The mobile information terminal according to claim 26, wherein said display controller determines whether or not said predetermined requirement is satisfied based on an operation position on said touch panel.

34. The mobile information terminal according to claim 26, wherein said display controller determines whether or not said predetermined requirement is satisfied based on whether or not a shift distance from the position at which the operation on said touch panel is started is longer than a predetermined threshold value.

35. The mobile information terminal according to claim 26, wherein said display controller continues displaying said operation window having been shifted in the display position by said first operation, at a shifted position after said first operation is terminated.

36. The mobile information terminal according to claim 26, wherein when an operation, different from said first operation, of selecting from among said, items is performed on said touch panel after said display controller shifts the display position of said operation window on said display unit by said first operation, said execution unit executes the processing related to said application corresponding to a selected item.

37. The mobile information terminal according to claim 36, wherein after processing corresponding to said selected item is executed, said display controller returns the display position of said operation window on said display unit shifted by said first operation to a position before being shifted.

38. The mobile information terminal according to claim 26, wherein, after said first operation is terminated, said display controller returns the display position of said operation window on said display unit shifted by said first operation to a position before being shifted.

39. A non-transitory tangible recording medium storing a program to be executed by a processor of a mobile information terminal comprising a display unit and a touch panel arranged in said display unit, said program causing said processor to execute the steps of:
displaying, on said display unit, an operation window including items;
executing processing related to an application corresponding to said items, in accordance with a touch operation of selecting from among said items on said operation window; and
shifting a display position of said operation window in accordance with that a position at which an operation on said touch panel is started falls within a display area of said operation window and that the operation on said touch panel is an operation satisfying a predetermined requirement.

40. A mobile information terminal comprising:
a display box;
a touch panel arranged in said display box; and
an execution unit executing an application, wherein
said execution unit executes processing related to said application in accordance with an operation on said touch panel,
an operation window of said application is larger than a size of said display box,
said execution unit displays, on said display box, a partial window constituting a portion of said operation window,
said partial window includes items,
said execution unit,
executes the processing related to said application in accordance with a touch operation on said items,
in accordance with a first touch operation on said touch panel, changes the portion of said operation window displayed on said display box as said partial window, and determining that a selection from among said items has been made by a second touch operation performed on said partial window as changed, executes the processing related to said application corresponding to a selected item,
when said first touch operation is performed with an area of said partial window in said operation window located at an end of said operation window, changes the area in said operation window displayed on said display box as said partial window such that the end of said operation window is displayed at a shifted position in said display box from an end of said display box in a direction identical to an operation direction in said first touch operation, and
when said second touch operation is performed on said partial window as changed, determining that a selection from among said items has been made, executes the processing related to said application corresponding to the selected item.
